(19) United States
(12) Patent Application Publication
(10) Pub. No.: US 2026/0319227 A1
(43) Pub. Date: Oct. 15, 2026

(54) OPTICAL IMAGING SYSTEM

(71) Applicant: Samsung Electro-Mechanics Co., Ltd., Suwon-si (KR)

(72) Inventors: Tae Sik RYU, Suwon-si (KR); Tae Yeon LIM, Suwon-si (KR); Seong Il CHO, Suwon-si (KR); Geon Hwi PARK, Suwon-si (KR); Yong Joo JO, Suwon-si (KR); Jin Hwa JUNG, Suwon-si (KR); Jae Hyuk HUH, Suwon-si (KR); Il Yong PARK, Suwon-si (KR)

(73) Assignee: Samsung Electro-Mechanics Co., Ltd., Suwon-si (KR)

(21) Appl. No.: 19/463,435

(22) Filed: Jan. 29, 2026

(30) Foreign Application Priority Data
Feb. 19, 2025 (KR) 10-2025-0021499
Nov. 20, 2025 (KR) 10-2025-0177278

(51) Int. Cl. G02B 13/00; G02B 9/62; G02B 27/64; H04N 23/55

(52) U.S. Cl. CPC G02B 13/007; G02B 9/62; G02B 13/0045; G02B 27/646; H04N 23/55

(57) ABSTRACT

An optical imaging system includes a first lens group having a positive refractive power and a second lens group having a positive refractive power sequentially disposed in ascending numerical order along an optical axis of the optical imaging system from an object side of the optical imaging system toward an imaging plane of the optical imaging system, wherein the first lens group includes a first reflective member including a first reflective surface, the second lens group includes a plurality of lenses, the optical imaging system further includes a second reflective member disposed behind the second lens group, the second reflective member includes a second reflective surface and a third reflective surface, and 0.50<fG1/fG2<2.50 is satisfied, where fG1 is a focal length of the first lens group, and fG2 is a focal length of the second lens group.

### CROSS-REFERENCE TO RELATED APPLICATIONS

This application claims the benefit under 35 USC 119 (a) of Korean Patent Application Nos. 10-2025-0021499 filed on Feb. 19, 2025, and 10-2025-0177278 filed on Nov. 20, 2025, in the Korean Intellectual Property Office, the entire disclosures of which are incorporated herein by reference for all purposes.

### BACKGROUND

### 1. Field

The present disclosure relates to an optical imaging system.

### 2. Description of Background

A portable terminal may include a camera module to enable video calling and image capturing, and the camera module may include an optical imaging system including a plurality of lenses.

Recently, even in camera modules for portable terminals, an optical imaging system having a narrow field of view (for example, a telephoto lens) has been applied. However, due to the physical characteristics of the portable terminal, there are technical difficulties in implementing such an optical imaging system to have a small size and a low F-number (Fno).

Therefore, there is a need for research into a structure of an optical imaging system having a small size and a low Fno that can be applied to a portable terminal.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a first lens group having a positive refractive power and a second lens group having a positive refractive power sequentially disposed in ascending numerical order along an optical axis of the optical imaging system from an object side of the optical imaging system toward an imaging plane of the optical imaging system, wherein the first lens group includes a first reflective member including a first reflective surface, the second lens group includes a plurality of lenses, the optical imaging system further includes a second reflective member disposed behind the second lens group, the second reflective member includes a second reflective surface and a third reflective surface, and 0.50<fG1/fG2<2.50 is satisfied, where fG1 is a focal length of the first lens group, and fG2 is a focal length of the second lens group.

The second reflective surface may be disposed behind the second lens group, the third reflective surface may be spaced apart from the second reflective surface in a direction perpendicular to an optical axis of the second lens group, and the second reflective member may be configured to be movable along an optical axis of the second lens group.

0.50<a/f<1.00 may be satisfied, where a is a distance between a center of the first reflective surface and a center of the second reflective surface when the second reflective member is disposed at a closest position to the second lens group, and f is an overall focal length of the optical imaging system.

0.30<a/TTL<0.60 may be satisfied, where a is a distance between a center of the first reflective surface and a center of the second reflective surface when the second reflective member is disposed at a closest position to the second lens group, and TTL is a sum of a distance along the optical axis of the optical imaging system from a first surface of the first lens group to the first reflective surface, a distance along the optical axis of the optical imaging system from the first reflective surface to the second reflective surface, a distance along the optical axis of the optical imaging system from the second reflective surface to the third reflective surface, and a distance along the optical axis of the optical imaging system from the third reflective surface to the imaging plane.

0.100<AFd/(f−fi)<0.600 may be satisfied, where AFd is a distance between a position of the second reflective member disposed at a closest position to the second lens group and a position of the second reflective member disposed at a farthest position from the second lens group, f is an overall focal length of the optical imaging system, and fi is (object distance×f)/(object distance+f).

The optical imaging system may further include an image sensor including the imaging plane, wherein the image sensor may be spaced apart from the third reflective surface in a direction parallel to an optical axis of the second lens group, the second reflective surface and the third reflective surface may be spaced apart from each other in a direction perpendicular to the optical axis of the second lens group, and h2+Him<b may be satisfied, where h2 is an effective radius of an object-side surface of a first lens closest to the first lens group among the plurality of lenses of the second lens group, Him is one half of a length of the imaging plane in the direction in which the second reflective surface and the third reflective surface are spaced apart from each other, and b is a distance between a center of the second reflective surface and a center of the third reflective surface.

0.20<f/fG1<0.90 may be satisfied, where f is an overall focal length of the optical imaging system.

0.40<f/fG2<1.10 may be satisfied, where f is an overall focal length of the optical imaging system.

0.10<RG1_S1/fG1<0.60 may be satisfied, where RG1_S1 is a radius of curvature of a first surface of the first lens group.

0.60<fG1/TTL<1.60 may be satisfied, where TTL is a sum of a distance along the optical axis from a first surface of the first lens group to the first reflective surface, a distance along the optical axis from the first reflective surface to the second reflective surface, a distance along the optical axis from the second reflective surface to the third reflective surface, and a distance along the optical axis from the third reflective surface to the imaging plane.

3.50<f/h1<5.50 may be satisfied, where f is an overall focal length of the optical imaging system, and h1 is an effective radius of a first surface of the first lens group.

0.40<h2/h1<0.80 may be satisfied, where h1 is an effective radius of a first surface of the first lens group, and h2 is an effective radius of an object-side surface of a first lens closest to the first lens group among the plurality of lenses of the second lens group.

0.40<BFL/TTL<0.70 may be satisfied, where BFL is a sum of a distance along the optical axis from a last surface of the second lens group to the second reflective surface, a distance along the optical axis from the second reflective surface to the third reflective surface, and a distance along the optical axis from the third reflective surface to the imaging plane, and TTL is a sum of a distance along the optical axis from a first surface of the first lens group to the first reflective surface, a distance along the optical axis from the first reflective surface to the second reflective surface, a distance along the optical axis from the second reflective surface to the third reflective surface, and a distance along the optical axis from the third reflective surface to the imaging plane.

The first reflective member may further include an incident surface and an exit surface, and a paraxial region of the incident surface may have a convex shape.

The first lens group may further include a front lens disposed in front of the first reflective member, and the front lens may have a positive refractive power.

The plurality of lenses of the second lens group may include a first lens having a positive refractive power; a second lens having a refractive power; a third lens having a negative refractive power; a fourth lens having a refractive power; and a fifth lens having a positive refractive power, and the first lens through the fifth lens may be sequentially disposed in ascending numerical order along an optical axis of the second lens group from an object side of the second lens group toward an image side of the second lens group.

The second lens may have a negative refractive power, and the fourth lens may have a positive refractive power.

The optical imaging system may further include an image sensor including the imaging plane, wherein the image sensor may be spaced apart from the third reflective surface in a direction parallel to an optical axis of the second lens group, the second reflective surface and the third reflective surface may be spaced apart from each other in a direction perpendicular to the optical axis of the second lens group, and 0.50<(h2+Him)/b<0.80 may be satisfied, where h2 is an effective radius of an object-side surface of a first lens closest to the first lens group among the plurality of lenses of the second lens group, Him is one half of a length of the imaging plane in the direction in which the second reflective surface and the third reflective surface are spaced apart from each other, and b is a distance between a center of the second reflective surface and a center of the third reflective surface.

0.15<|(RG1_S1−RG1_S2)/(RG1_S1+RG1_S2)|<0.60 may be satisfied, where RG1_S1 is a radius of curvature of a first surface of the first lens group, and RG1_S2 is a radius of curvature of a last surface of the first lens group having a curvature.

0<h2/fG1<0.1 may be satisfied, where h2 is an effective radius of an object-side surface of a first lens closest to the first lens group among the plurality of lenses of the second lens group.

7.0<TTL/(2×IMG HT)<11.0 may be satisfied, where TTL is a sum of a distance along the optical axis from a first surface of the first lens group to the first reflective surface, a distance along the optical axis from the first reflective surface to the second reflective surface, a distance along the optical axis from the second reflective surface to the third reflective surface, and a distance along the optical axis from the third reflective surface to the imaging plane, and IMG HT is one half of a diagonal length of the imaging plane.

Other features and aspects will be apparent from the following detailed description, the drawings, and the claims.

### BRIEF DESCRIPTION OF DRAWINGS

FIG. 1 is a schematic side view of an optical imaging system according to an embodiment of the present disclosure.

FIG. 2 is a schematic plan view of the optical imaging system illustrated in FIG. 1.

FIG. 3 is a schematic side view of an optical imaging system according to another embodiment of the present disclosure.

FIG. 4 is a schematic plan view of the optical imaging system illustrated in FIG. 3.

FIG. 5 is a configuration diagram of an optical imaging system according to a first embodiment of the present disclosure.

FIG. 6 is graphs illustrating aberration characteristics of the optical imaging system illustrated in FIG. 5.

FIG. 7 is a configuration diagram of an optical imaging system according to a second embodiment of the present disclosure.

FIG. 8 is graphs illustrating aberration characteristics of the optical imaging system illustrated in FIG. 7.

FIG. 9 is a configuration diagram of an optical imaging system according to a third embodiment of the present disclosure.

FIG. 10 is graphs illustrating aberration characteristics of the optical imaging system illustrated in FIG. 9.

FIG. 11 is a configuration diagram of an optical imaging system according to a fourth embodiment of the present disclosure.

FIG. 12 is graphs illustrating aberration characteristics of the optical imaging system illustrated in FIG. 11.

FIG. 13 is a configuration diagram of an optical imaging system according to a fifth embodiment of the present disclosure.

FIG. 14 is graphs illustrating aberration characteristics of the optical imaging system illustrated in FIG. 13.

FIG. 15 is a configuration diagram of an optical imaging system according to a sixth embodiment of the present disclosure.

FIG. 16 is graphs illustrating aberration characteristics of the optical imaging system illustrated in FIG. 15.

FIG. 17 is a configuration diagram of an optical imaging system according to a seventh embodiment of the present disclosure.

FIG. 18 is graphs illustrating aberration characteristics of the optical imaging system illustrated in FIG. 17.

FIG. 19 is a configuration diagram of an optical imaging system according to an eighth embodiment of the present disclosure.

FIG. 20 is graphs illustrating aberration characteristics of the optical imaging system illustrated in FIG. 19.

FIG. 21 is a configuration diagram of an optical imaging system according to a ninth embodiment of the present disclosure.

FIG. 22 is graphs illustrating aberration characteristics of the optical imaging system illustrated in FIG. 21.

FIG. 23 is a configuration diagram of an optical imaging system according to a tenth embodiment of the present disclosure.

FIG. 24 is graphs illustrating aberration characteristics of the optical imaging system illustrated in FIG. 23.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

In the drawings, thicknesses, sizes, and shapes of lenses may be exaggerated for illustrative purposes. In particular, a shape of a spherical or aspherical surface illustrated in the drawings is presented only as an example, but the present disclosure is not limited thereto.

In addition, as used herein, all numerical values of a radius of curvature, a thickness, a distance, a focal length, and other measurements of a lens or other element may be expressed in millimeters (mm), and a field of view (FOV) may be expressed in degrees (°).

In addition, in the description of a shape of a lens, a statement that a surface of a lens has a convex shape means that a paraxial region of the surface has a convex shape, and a statement that a surface of a lens has a concave shape means that a paraxial region of the surface has a concave shape.

Accordingly, even when it is described that a surface of a lens has a convex shape, an edge portion of the lens may have a concave shape. Similarly, even when it is described that a surface of a lens has a concave shape, an edge portion of the lens may have a convex shape.

A paraxial region of a lens surface is a very narrow region around an optical axis of the lens surface.

In greater detail, a paraxial region of a lens surface is a central portion of the lens surface surrounding and including the optical axis of the lens surface in which light rays incident to the lens surface make a small angle θ to the optical axis, and the approximations sin θ≈θ, tan θ≈θ, and cos θ≈1 are valid.

An imaging plane may refer to a virtual surface on which a focal point is formed by the optical imaging system. Alternatively, the imaging plane may refer to one surface of an image sensor receiving light on which a focal point is formed.

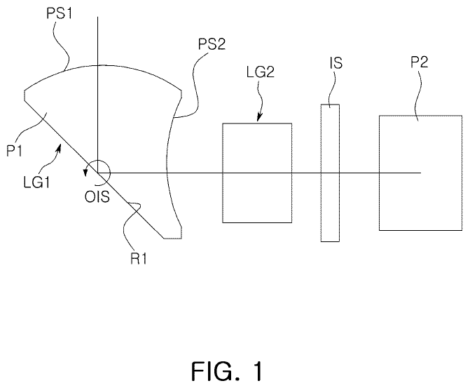

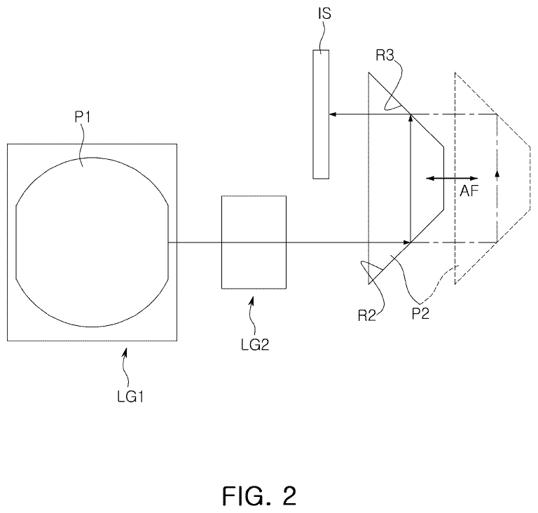

FIG. 1 is a schematic side view of an optical imaging system according to an embodiment of the present disclosure, and FIG. 2 is a schematic plan view of the optical imaging system illustrated in FIG. 1.

Referring to FIGS. 1 and 2, an optical imaging system according to an embodiment of the present disclosure may include a plurality of lens groups. In an example, the optical imaging system may include a first lens group LG1 and a second lens group LG2.

The first lens group LG1 and the second lens group LG2 may each have a refractive power. For example, the first lens group LG1 may have a positive refractive power, and the second lens group LG2 may have a positive refractive power.

The optical imaging system according to an embodiment of the present disclosure may further include a first reflective member P1 having a reflective surface changing a direction of light travel. The first reflective member P1 may be a mirror or a prism. The first reflective member P1 may be a component included in the first lens group LG1.

By bending a path of light through the first reflective member P1, an optical path may be formed to be long in a relatively narrow space.

Accordingly, the optical imaging system may be allowed to have a long focal length, while the optical imaging system is reduced in size.

The optical imaging system according to an embodiment of the present disclosure may have characteristics of a telephoto lens having a relatively narrow field of view and a long focal length.

The first lens group LG1 may include the first reflective member P1, and the second lens group LG2 may include a plurality of lenses.

The first reflective member P1 may include an incident surface PS1, a first reflective surface R1, and an exit surface PS2. The incident surface PS1 may be disposed in front of the first reflective surface R1, and the exit surface PS2 may be disposed behind the first reflective surface R1. Light reflected from an object may be incident on the incident surface PS1 of the first reflective member P1, light incident on the incident surface PS1 may be reflected from the first reflective surface R1, and light reflected from the first reflective surface R1 may exit through the exit surface PS2.

Either one or both of the incident surface PS1 and the exit surface PS2 may have a curvature. For example, a paraxial region of the incident surface PS1 may have a convex shape, and a paraxial region of the exit surface PS2 may have a concave shape.

In the embodiment of FIGS. 1 and 2, a first surface of the first lens group LG1 may refer to the incident surface PS1. A last surface of the first lens group LG1 may refer to the exit surface PS2.

Either one or both of the incident surface PS1 and the exit surface PS2 of the first reflective member P1 may be an aspherical surface. In an embodiment, the incident surface PS1 may be an aspherical surface, and the exit surface PS2 may be a spherical surface.

Accordingly, light reflected from a subject may be refracted while being incident on the incident surface PS1, and may be incident on the first reflective surface R1. Light reflected from the first reflective surface R1 may be refracted while exiting through the exit surface PS2. That is, the first reflective member P1 may be a component having a refractive power.

In order to reduce a size of the optical imaging system, it may be necessary to reduce diameters of lenses included in the second lens group LG2 disposed behind the first reflective member P1. However, as the diameters of the lenses decrease, an F-number (Fno) of the optical imaging system may increase, causing an issue of a captured image being too dark.

Accordingly, the optical imaging system according to an embodiment of the present disclosure may reduce the Fno of the optical imaging system by allowing the first reflective member P1 to have a positive refractive power.

The first reflective member P1 may be configured to have a positive refractive power so that the first reflective member P1 may serve as a convex lens (that is, light exiting from the first reflective member P1 may be refracted to converge).

Accordingly, the second lens group LG2 may be configured to have a small diameter. Thus, while the Fno of the optical imaging system is reduced, a size of the optical imaging system (a height in a direction in which light is incident on the incident surface of the first reflective member P1) may be reduced.

The first reflective member P1 may be disposed in front of the second lens group LG2. The first reflective member P1 may rotate about two axes so as to perform optical image stabilization (OIS) during image capturing.

That is, when shaking occurs due to factors such as user hand tremor or the other disturbance during image capturing or video recording, shaking may be compensated by rotating the first reflective member P1 about two axes in response to the shaking or other disturbance.

A second reflective member P2 may be disposed behind the second lens group LG2. The second reflective member P2 may have a plurality of reflective surfaces. For example, the second reflective member P2 may include a second reflective surface R2 and a third reflective surface R3. The second reflective member P2 may be a single member including the second reflective surface R2 and the third reflective surface R3, but the present disclosure is not limited thereto, and a reflective member having the second reflective surface R2 and a reflective member having the third reflective surface R3 may be provided as separate components.

The second reflective surface R2 may be disposed behind the second lens group LG2, and the third reflective surface R3 may be spaced apart from the second reflective surface R2 in a direction perpendicular to an optical axis of the second lens group LG2.

Light having passed through the second lens group LG2 may be reflected from the second reflective surface R2, and light reflected from the second reflective surface R2 may be reflected again from the third reflective surface R3.

Light reflected from the third reflective surface R3 may be incident on an imaging plane of the image sensor IS. Light reflected from the third reflective surface R3 may be substantially parallel to the optical axis of the second lens group LG2.

The imaging plane of the image sensor IS may be spaced from the third reflective surface R3 in a direction of the optical axis of the second lens group LG2.

In an embodiment, light having passed through the second lens group LG2 may be reflected from the second reflective surface R2 by about 90°. In addition, light reflected from the second reflective surface R2 may be reflected from the third reflective surface R3 by about 90°. That is, light having passed through the second lens group LG2 may be reflected in a “U” shape by the second reflective member P2.

In an embodiment, the second reflective member P2 may have a rectangular pillar shape having two trapezoidal surfaces.

The second reflective member P2 may move in an optical axis direction of the second lens group LG2 (or a direction parallel to the optical axis of the second lens group LG2).

Accordingly, a distance between the second lens group LG2 and the image sensor IS may be changed by moving the second reflective member P2 so that an auto-focusing (AF) function may be implemented.

In addition, the light may be reflected twice by the second reflective member P2 so that a moving distance of the second reflective member P2 during auto-focusing may be significantly reduced.

Accordingly, the optical imaging system may be reduced in size.

In an embodiment, when an object distance is infinity, a distance between the second reflective member P2 and the second lens group LG2 may be a minimum. When the object distance is an arbitrary finite distance, the second reflective member P2 may move in direction away from the second lens group LG2.

The second lens group LG2 may include a plurality of lenses. The plurality of lenses may be spaced apart from each other by predetermined distances along the optical axis of the second lens group LG2.

In an embodiment, the second lens group LG2 may include a first lens, a second lens, a third lens, a fourth lens, and a fifth lens sequentially disposed in ascending numerical order along an optical axis of the second lens group LG2 from an object side of the second lens group LG2 toward an image side of the second lens group LG2.

The first lens may have a positive refractive power. In addition, the first lens may have a meniscus shape convex toward the object side. For example, a paraxial region of an object-side surface of the first lens may have a convex shape, and a paraxial region of an image-side surface of the first lens may have a concave shape.

Alternatively, respective paraxial regions of both surfaces of the first lens may have a convex shape. For example, a paraxial region of the object-side surface of the first lens and a paraxial region of the image-side surface of the first lens may each have a convex shape.

The second lens may have a negative refractive power. In addition, the second lens may have a meniscus shape convex toward the object side. For example, a paraxial region of an object-side surface of the second lens may have a convex shape, and a paraxial region of an image-side surface of the second lens may have a concave shape.

The third lens may have a negative refractive power. In addition, respective paraxial regions of both surfaces of the third lens may have a concave shape. For example, a paraxial region of an object-side surface of the third lens and a paraxial region of an image-side surface of the third lens may each have a concave shape.

The fourth lens may have a positive refractive power. In addition, respective paraxial regions of both surfaces of the fourth lens may have a convex shape. For example, a paraxial region of an object-side surface of the fourth lens and a paraxial region of an image-side surface of the fourth lens may each have a convex shape.

Alternatively, the fourth lens may have a meniscus shape convex toward an image side. For example, a paraxial region of the object-side surface of the fourth lens may have a concave shape, and a paraxial region of the image-side surface of the fourth lens may have a convex shape.

The fifth lens may have a positive refractive power. In addition, respective paraxial regions of both surfaces of the fifth lens may have a convex shape. For example, a paraxial region of an object-side surface of the fifth lens and a paraxial region of an image-side surface of the fifth lens may each have a convex shape.

The optical imaging system may further include an image sensor IS for converting an image of an subject incident on the image sensor IS into an electrical signal. Light reflected from the third reflective surface R3 of the second reflective member P2 may be received by an imaging plane of the image sensor IS.

Referring to FIG. 1, in a side view of the optical imaging system, the image sensor IS may be seen as being positioned between the second lens group LG2 and the second reflective member P2.

In addition, the optical imaging system may further include an infrared filter (not shown) for blocking infrared light. The filter may be disposed between the image sensor IS and the second reflective member P2. For example, the filter may be disposed between the image sensor IS and the third reflective surface R3.

In addition, the optical imaging system may further include a stop for adjusting an amount of light passing through the optical imaging system. The stop may be disposed between the second lens and the third lens.

The plurality of lenses included in the second lens group LG2 may be made of a plastic material.

In addition, at least one of the plurality of lenses may have an aspherical surface.

In an embodiment, the object-side surface and the image-side surface of each of the first lens through the fifth lens may be aspherical surfaces.

The aspherical surfaces of each lens may be represented by Equation 1 below.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + {GY}^{16} + {HY}^{18} \qquad ( 1 )$$

In Equation 1, c is a curvature of the lens surface and is equal to a reciprocal of a radius of curvature of the lens surface at an optical axis of the lens surface, K is a conic constant, and Y is a distance from any point on the aspherical surface of the lens to the optical axis. In addition, constants A to H are aspherical surface coefficients. Z (also known as sag) is a distance in a direction parallel to an optical axis direction between the point on the aspherical surface of the lens at the distance Y from the optical axis of the aspherical surface to a tangential plane perpendicular to the optical axis and intersecting a vertex of the aspherical surface.

The optical imaging system may satisfy any one or any combination of any two or more of the following Conditional Expressions 1 to 46.

0.50<fG1/fG2<2.50 (Conditional Expression 1)

0.82<fG1/fG2<2.17 (Conditional Expression 2)

0.913<fG1/fG2<1.972 (Conditional Expression 3)

h2+Him<b (Conditional Expression 4)

0.50<a/f<1.00 (Conditional Expression 5)

0.62<a/f<0.86 (Conditional Expression 6)

0.691<a/f≤0.782 (Conditional Expression 7)

0.100<AFd/(f−fi)<0.600 (Conditional Expression 8)

0.410<AFd/(f−fi)<0.520 (Conditional Expression 9)

0.456≤AFd/(f−fi)<0.474 (Conditional Expression 10)

0.50<(h2+Him)/b<0.80 (Conditional Expression 11)

0.54<(h2+Him)/b<0.73 (Conditional Expression 12)

0.602≤(h2+Him)/b≤0.666 (Conditional Expression 13)

0.20<f/fG1<0.90 (Conditional Expression 14)

0.40<f/fG1<0.78 (Conditional Expression 15)

0.436≤f/fG1≤0.710 (Conditional Expression 16)

0.40<f/fG2<1.10 (Conditional Expression 17)

0.58<f/fG2<0.95 (Conditional Expression 18)

0.648<f/fG2<0.861 (Conditional Expression 19)

0.10<RG1_S1/fG1<0.60 (Conditional Expression 20)

0.20<RG1_S1/fG1<0.40 (Conditional Expression 21)

0.216<RG1_S1/fG1<0.364 (Conditional Expression 22)

0.60<fG1/TTL<1.60 (Conditional Expression 23)

0.80<fG1/TTL<1.55 (Conditional Expression 24)

0.886≤fG1/TTL<1.469 (Conditional Expression 25)

3.50<f/h1<5.50 (Conditional Expression 26)

3.70<f/h1<5.20 (Conditional Expression 27)

3.973≤f/h1<4.912 (Conditional Expression 28)

0.30<a/TTL<0.60 (Conditional Expression 29)

0.40<a/TTL<0.52 (Conditional Expression 30)

0.435≤a/TTL<0.483 (Conditional Expression 31)

0.40<h2/h1<0.80 (Conditional Expression 32)

0.50<h2/h1<0.70 (Conditional Expression 33)

0.512≤h2/h1<0.662 (Conditional Expression 34)

0.40<BFL/TTL<0.70 (Conditional Expression 35)

0.45<BFL/TTL<0.60 (Conditional Expression 36)

0.475≤BFL/TTL<0.524 (Conditional Expression 37)

0.15<|(RG1_S1−RG1_S2)/(RG1_S1+RG1_S2)|<0.60 (Conditional Expression 38)

0.20<|(RG1_S1−RG1_S2)/(RG1_S1+RG1_S2)|<0.52 (Conditional Expression 39)

0.221<|(RG1_S1−RG1_S2)/(RG1_S1+RG1_S2)|≤0.479 (Conditional Expression 40)

0<h2/fG1<0.1 (Conditional Expression 41)

0.05<h2/fG1<0.09 (Conditional Expression 42)

0.058≤h2/fG1≤0.083 (Conditional Expression 43)

7.0<TTL/(2×IMG HT)<11.0 (Conditional Expression 44)

7.48<TTL/(2×IMG HT)<10.28 (Conditional Expression 45)

8.312≤TTL/(2×IMG HT)≤9.344 (Conditional Expression 46)

In an embodiment, the optical imaging system may satisfy 0.50<fG1/fG2<2.50 (Conditional Expression 1). Here, fG1 may be a focal length of the first lens group LG1, and fG2 may be a focal length of the second lens group LG2.

The optical imaging system may satisfy 0.50<fG1/fG2<2.50, thereby reducing a size thereof (for example, a height in a direction in which light is incident on the incident surface of the first reflective member).

Preferably, the optical imaging system may satisfy 0.82<fG1/fG2<2.17 (Conditional Expression 2). More preferably, the optical imaging system may satisfy 0.913<fG1/fG2<1.972 (Conditional Expression 3).

In an embodiment, the optical imaging system may satisfy h2+Him<b (Conditional Expression 4). Here, h2 may be an effective radius of the object-side surface of the first lens of the second lens group LG2, Him may be one half of a length of the imaging plane in a horizontal direction, and b may be a distance between a center of the second reflective surface R2 and a center of the third reflective surface R3 in the horizontal direction. The horizontal direction may refer to a direction from the second reflective surface R2 to the third reflective surface R3 (or an opposite direction thereof).

The optical imaging system may satisfy h2+Him<b, thereby reducing a size thereof (for example, a length of the second lens group LG2 in the optical axis direction).

In an embodiment, the optical imaging system may satisfy 0.50<a/f<1.00 (Conditional Expression 5). Here, a may be a distance between a center of the first reflective surface R1 of the first reflective member P1 and a center of the second reflective surface R2 of the second reflective member P2 when the object distance is infinity (that is, when the second reflective member P2 is at a closest position to the second lens group LG2), and f may be an overall focal length of the optical imaging system.

The optical imaging system may satisfy 0.50<a/f<1.00, thereby reducing a size thereof (for example, a length of the second lens group in the optical axis direction).

Preferably, the optical imaging system may satisfy 0.62<a/f<0.86 (Conditional Expression 6). More preferably, the optical imaging system may satisfy 0.691<a/f≤0.782 (Conditional Expression 7).

In an embodiment, the optical imaging system may satisfy 0.100<AFd/(f−fi)<0.600 (Conditional Expression 8). Here, AFd may be an amount of movement of the second reflective member P2 between a position when the object distance is infinity and a position when the object distance is a minimum, and fi may be (object distance×f)/(object distance+f). In the present embodiment, a minimum value of the object distance may be 300 mm, so fi_300 may be (300×f)/(300+f). The amount of movement of the second reflective member P2 may be a distance between a position of the second reflective member P2 disposed at a closest position to the second lens group LG2 (when the object distance is infinity) and a position of the second reflective member P2 disposed at a farthest position from the second lens group LG2 (when the object distance is a minimum). The object distance is a distance between an object and a first surface of the first lens group LG1.

The optical imaging system may satisfy 0.100<AFd/(f−fi)<0.600, thereby reducing a size thereof (for example, a length of the second lens group in the optical axis direction).

Preferably, the optical imaging system may satisfy 0.410<AFd/(f−fi)<0.520 (Conditional Expression 9). More preferably, the optical imaging system may satisfy 0.456≤AFd/(f−fi)<0.474 (Conditional Expression 10).

In an embodiment, the optical imaging system may satisfy 0.50< (h2+Him)/b<0.80 (Conditional Expression 11).

Accordingly, the optical imaging system may reduce a size thereof (for example, a length of the second lens group LG2 in the optical axis direction).

Preferably, the optical imaging system may satisfy 0.54<(h2+Him)/b<0.73 (Conditional Expression 12). More preferably, the optical imaging system may satisfy 0.602≤(h2+Him)/b≤0.666 (Conditional Expression 13).

In an embodiment, the optical imaging system may satisfy 0.20<f/fG1<0.90 (Conditional Expression 14).

Accordingly, diameters of lenses included in the second lens group LG2 may be reduced by optimizing the focal length of the first lens group LG1 having a positive refractive power.

Preferably, the optical imaging system may satisfy 0.40<f/fG1<0.78 (Conditional Expression 15). More preferably, the optical imaging system may satisfy 0.436≤f/fG1≤0.710 (Conditional Expression 16).

In an embodiment, the optical imaging system may satisfy 0.40<f/fG2<1.10 (Conditional Expression 17).

Accordingly, a resolution may be improved by optimizing the focal length of the second lens group LG2.

Preferably, the optical imaging system may satisfy 0.58<f/fG2<0.95 (Conditional Expression) 18. More preferably, the optical imaging system may satisfy 0.648<f/fG2<0.861 (Conditional Expression 19).

In an embodiment, the optical imaging system may satisfy 0.10<RG1_S1/fG1<0.60 (Conditional Expression 20). Here, RG1_S1 may be a radius of curvature of the first surface of the first lens group LG1. The first surface of the first lens group LG1 may be a surface closest to the object side of the optical imaging system.

Accordingly, occurrence of aberrations may be minimized.

Preferably, the optical imaging system may satisfy 0.20<RG1_S1/fG1<0.40 (Conditional Expression 21). More preferably, the optical imaging system may satisfy 0.216<RG1_S1/fG1<0.364 (Conditional Expression 22).

In an embodiment, the optical imaging system may satisfy 0.60<fG1/TTL<1.60 (Conditional Expression 23). Here, TTL may be a sum of a distance along the optical axis from the first surface of the first lens group LG1 to the first reflective surface R1 of the first reflective member P1, a distance along the optical axis from the first reflective surface R1 of the first reflective member P1 to the second reflective surface R2 of the second reflective member P2, a distance along the optical axis from the second reflective surface R2 of the second reflective member P2 to the third reflective surface R3 of the second reflective member P2, and a distance along the optical axis from the third reflective surface R3 of the second reflective member P2 to the imaging plane. As used herein, TTL may be based on a position of the second reflective member P2 when the object distance is infinity.

Accordingly, the optical imaging system may be reduced in size by optimizing the focal length of the first lens group LG1.

Preferably, the optical imaging system may satisfy 0.80<fG1/TTL<1.55 (Conditional Expression 24). More preferably, the optical imaging system may satisfy 0.886≤fG1/TTL<1.469 (Conditional Expression 25).

In an embodiment, the optical imaging system may satisfy 3.50<f/h1<5.50 (Conditional Expression 26). Here, h1 may be an effective radius of the first surface of the first lens group LG1.

Accordingly, an image brightness and a resolution may be improved.

Preferably, the optical imaging system may satisfy 3.70<f/h1<5.20 (Conditional Expression 27). More preferably, the optical imaging system may satisfy 3.973≤f/h1<4.912 (Conditional Expression 28).

In an embodiment, the optical imaging system may satisfy 0.30<a/TTL<0.60 (Conditional Expression 29).

Accordingly, the optical imaging system may be reduced in size.

Preferably, the optical imaging system may satisfy 0.40<a/TTL<0.52 (Conditional Expression 30). More preferably, the optical imaging system may satisfy 0.435≤a/TTL<0.483 (Conditional Expression 31).

In an embodiment, the optical imaging system may satisfy 0.40<h2/h1<0.80 (Conditional Expression 32).

Accordingly, an image brightness may be improved, and the optical imaging system may be reduced in size.

Preferably, the optical imaging system may satisfy 0.50<h2/h1<0.70 (Conditional Expression 33). More preferably, the optical imaging system may satisfy 0.512≤h2/h1<0.662 (Conditional Expression 34).

In an embodiment, the optical imaging system may satisfy 0.40<BFL/TTL<0.70 (Conditional Expression 35). Here, BFL may be a sum of a distance along the optical axis from a last surface of the second lens group LG2 to the second reflective surface R2 of the second reflective member P2, a distance along the optical axis from the second reflective surface R2 of the second reflective member P2 to the third reflective surface R3 of the second reflective member P2, and a distance along the optical axis from the third reflective surface R3 of the second reflective member P2 to the imaging plane. The last surface of the second lens group LG2 may be a surface closest to the second reflective member P2 (for example, the image-side surface of the fifth lens). In addition, as used herein, BFL may be based on a position of the second reflective member P2 when the object distance is infinity.

Accordingly, the optical imaging system may be reduced in size.

Preferably, the optical imaging system may satisfy 0.45<BFL/TTL<0.60 (Conditional Expression 36). More preferably, the optical imaging system may satisfy 0.475≤BFL/TTL<0.524 (Conditional Expression 37).

In an embodiment, the optical imaging system may satisfy 0.15<| (RG1_S1−RG1_S2)/(RG1_S1+RG1_S2)|<0.60 (Conditional Expression 38). Here, RG1_S2 may be a radius of curvature of the last surface of the first lens group LG1. The last surface of the first lens group LG1 may refer to a surface closest to the second lens group LG2, among surfaces having a curvature of the first lens group LG1.

Accordingly, aberrations occurring in the first lens group LG1 may be minimized.

Preferably, the optical imaging system may satisfy 0.20<| (RG1_S1−RG1_S2)/(RG1_S1+RG1_S2)|<0.52 (Conditional Expression 39). More preferably, the optical imaging system may satisfy 0.221<| (RG1_S1−RG1_S2)/(RG1_S1+RG1_S2)|≤0.479 (Conditional Expression 40).

In an embodiment, the optical imaging system may satisfy 0<h2/fG1<0.1 (Conditional Expression 41).

Accordingly, a diameter of the first lens of the second lens group LG2 may be reduced by optimizing the focal length of the first lens group LG1 having a positive refractive power.

Preferably, the optical imaging system may satisfy 0.05<h2/fG1<0.09 (Conditional Expression 42). More preferably, the optical imaging system may satisfy 0.058≤h2/fG1≤0.083 (Conditional Expression 43).

In an embodiment, the optical imaging system may satisfy 7.0<TTL/(2×IMG HT)<11.0 (Conditional Expression 44). Here, IMG HT may be one half of a diagonal length of the imaging plane.

Accordingly, the optical imaging system may be reduced in size while a telephoto function having a narrow field of view is implemented.

Preferably, the optical imaging system may satisfy 7.48<TTL/(2×IMG HT)<10.28 (Conditional Expression 45). More preferably, the optical imaging system may satisfy 8.312≤TTL/(2×IMG HT)≤9.344 (Conditional Expression 46).

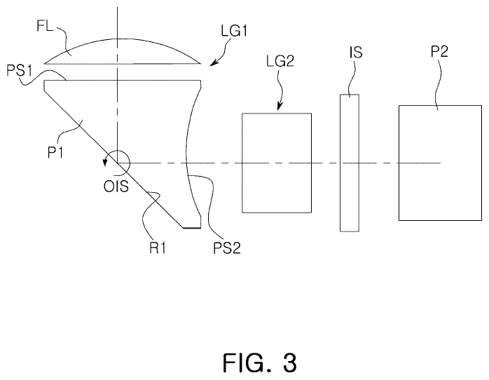

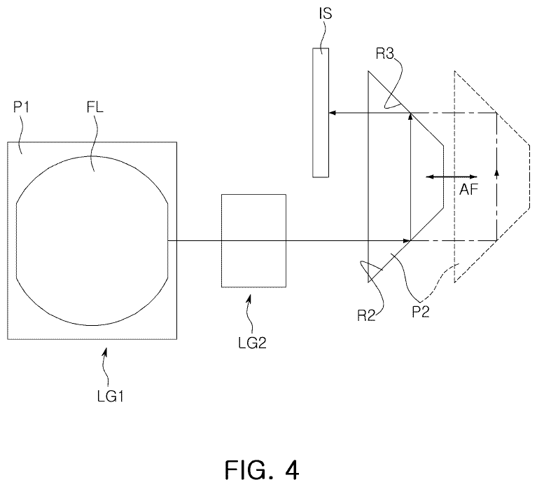

FIG. 3 is a schematic side view of an optical imaging system according to another embodiment of the present disclosure, and FIG. 4 is a schematic plan view of the optical imaging system illustrated in FIG. 3.

The embodiment illustrated in FIGS. 3 and 4 may differ from the embodiment illustrated in FIGS. 1 and 2 in terms of a configuration of a first lens group LG1.

The first lens group LG1 may further include a front lens FL disposed in front of a first reflective member P1. The first reflective member P1 may have a triangular pillar shape.

In an embodiment, an incident surface PS1 and an exit surface PS2 of the first reflective member P1 may be planar surfaces.

In an another embodiment, the incident surface PS1 of the first reflective member P1 may be a planar surface, and the exit surface PS2 may have a curvature. For example, a paraxial region of the exit surface PS2 may have a concave shape.

In the embodiment of FIGS. 3 and 4, a first surface of the first lens group LG1 may refer to an object-side surface of the front lens FL.

The front lens FL of the first lens group LG1 may include one or more lenses. The front lens FL may have a positive refractive power.

In an embodiment, the front lens FL may include a single lens. The front lens FL may have a positive refractive power. In addition, the front lens FL may have a meniscus shape convex toward an object side. For example, a paraxial region of the object-side surface of the front lens FL may have a convex shape, and a paraxial region of an image-side surface of the front lens FL may have a concave shape.

The front lens FL may be made of a plastic material, and either one or both of the object-side surface and the image-side surface of the front lens FL may be an aspherical surface.

In an embodiment, the object-side surface of the front lens FL may be an aspherical surface, and the image-side surface of the front lens FL may be a spherical surface.

In an embodiment, the object-side surface and the image-side surface of the front lens FL may both be aspherical surfaces.

An optical axis of the front lens FL and an optical axis of the second lens group LG2 may be perpendicular to each other. In an embodiment, an optical axis direction of the front lens FL may be substantially parallel to a thickness direction of a portable terminal in which the optical imaging system is mounted, and an optical axis direction of the second lens group LG2 may be substantially parallel to a length direction or a width direction of the portable terminal.

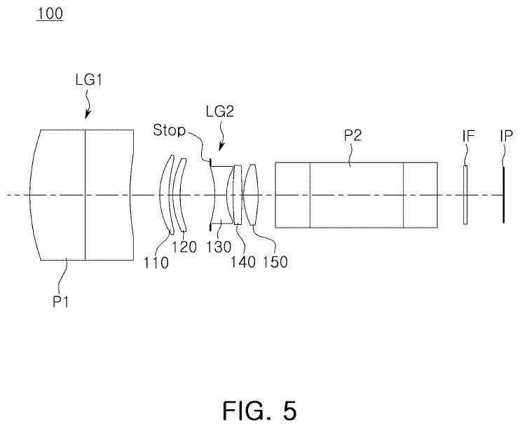

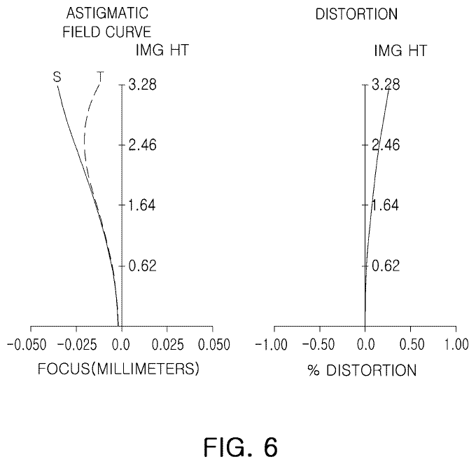

FIG. 5 is a configuration diagram of an optical imaging system according to a first embodiment of the present disclosure, and FIG. 6 is graphs illustrating aberration characteristics of the optical imaging system illustrated in FIG. 5.

An optical imaging system 100 according to a first embodiment of the present disclosure will be described with reference to FIGS. 5 and 6. FIG. 5 schematically illustrates an optical path of the optical imaging system 100 according to the first embodiment of the present disclosure in an unfolded state.

Referring to FIG. 5, an optical imaging system 100 according to the first embodiment of the present disclosure may include a first lens group LG1 and a second lens group LG2.

The first lens group LG1 may include a first reflective member P1, and the second lens group LG2 may include a first lens 110, a second lens 120, a third lens 130, a fourth lens 140, and a fifth lens 150 sequentially disposed in ascending numerical order along an optical axis of the second lens group LG2 from an object side of the second lens group LG2 toward an image side of the second lens group LG2.

The first reflective member P1 may include an incident surface PS1, a first reflective surface R1, and an exit surface PS2 as shown in FIG. 1.

The optical imaging system 100 may further include a second reflective member P2 disposed behind the second lens group LG2. The second reflective member P2 may include a second reflective surface R2 and a third reflective surface R3 as shown in FIG. 2.

In addition, the optical imaging system 100 may further include a filter IF and an imaging plane IP disposed after the second reflective member P2.

The imaging plane IP may refer to a surface on which a focal point is formed by the optical imaging system 100. For example, the imaging plane IP may refer to one surface of an image sensor IS on which light is received as shown in FIGS. 1 and 2.

A stop may be disposed between the second lens 120 and the third lens 130. For example, the stop may be disposed at an edge of an object-side surface of the third lens 130.

Characteristics of each element (a radius of curvature, a thickness of an element or a distance between elements, a refractive index, an Abbe number, and an effective radius) are listed in Table 1 below.

TABLE 1

| | Surface | Radius of | Thickness | Refractive | Abbe | Effective |
|---|---|---|---|---|---|---|
| Element | No. | Curvature | or Distance | Index | Number | Radius |
| First | S1 | 23.960 | 6.600 | 1.518 | 64.1 | 7.660 |
| Reflective | S2 | Infinity | 5.280 | 1.518 | 64.1 | 6.670 |
| Member | S3 | 47.185 | 3.403 | | | 5.617 |
| First | S4 | 9.479 | 1.053 | 1.547 | 55.9 | 4.650 |
| Lens | S5 | 34.872 | 0.464 | | | 4.574 |
| Second | S6 | 17.533 | 0.800 | 1.537 | 55.7 | 4.400 |
| Lens | S7 | 13.631 | 4.158 | | | 4.169 |
| Third | S8 (Stop) | −10.911 | 1.345 | 1.694 | 31.2 | 3.343 |
| Lens | S9 | 5.676 | 0.780 | | | 3.423 |
| Fourth | S10 | 172.150 | 1.088 | 1.678 | 19.2 | 3.472 |
| Lens | S11 | −33.012 | 0.100 | | | 3.550 |
| Fifth | S12 | 6.924 | 1.810 | 1.537 | 55.7 | 3.713 |
| Lens | S13 | −13.805 | 2.000 | | | 3.700 |
| Second | S14 | Infinity | 4.000 | 1.722 | 29.5 | 3.650 |
| Reflective | S15 | Infinity | 11.000 | 1.722 | 29.5 | 3.603 |
| Member | S16 | Infinity | 4.000 | 1.722 | 29.5 | 3.474 |
| | S17 | Infinity | 3.000 | | | 3.427 |
| Filter | S18 | Infinity | 0.210 | 1.519 | 64.2 | 3.366 |
| | S19 | Infinity | 4.346 | | | 3.364 |
| Imaging | S20 | Infinity | | | | 3.277 |
| Plane | | | | | | |

For reference, “Distance” in Table 1 may be based on a position of the second reflective member P2 when an object distance is infinity.

In the first embodiment of the present disclosure, the first reflective member P1 may have a positive refractive power, a paraxial region of the incident surface PS1 of the first reflective member P1 may have a convex shape, and a paraxial region of the exit surface PS2 of the first reflective member P1 may have a concave shape.

The first lens 110 may have a positive refractive power, a paraxial region of an object-side surface of the first lens 110 may have a convex shape, and a paraxial region of an image-side surface of the first lens 110 may have a concave shape.

The second lens 120 may have a negative refractive power, a paraxial region of an object-side surface of the second lens 120 may have a convex shape, and a paraxial region of an image-side surface of the second lens 120 may have a concave shape.

The third lens 130 may have a negative refractive power, and respective paraxial regions of an object-side surface and an image-side surface of the third lens 130 may each have a concave shape.

The fourth lens 140 may have a positive refractive power, and respective paraxial regions of an object-side surface and an image-side surface of the fourth lens 140 may each have a convex shape.

The fifth lens 150 may have a positive refractive power, and respective paraxial regions of an object-side surface and an image-side surface of the fifth lens 150 may each have a convex shape.

One surface of the first reflective member P1 and both surfaces of each of the first lens 110 through the fifth lens 150 may have aspherical surface coefficients as listed in Table 2 below. For example, the incident surface PS1 of the first reflective member P1 may be an aspherical surface, the exit surface of the first reflective member P1 may be a spherical surface, and both the object-side surface and the image-side surface of each of the first lens 110 through the fifth lens 150 may be aspherical surfaces.

TABLE 2

| | S1 | S4 | S5 | S6 | S7 | S8 |
|---|---|---|---|---|---|---|
| K | −7.852E−02 | 3.153E−01 | 4.144E+01 | 6.073E+00 | 1.056E−01 | 2.013E+00 |
| A | 6.728E−02 | −1.062E+00 | 9.107E−02 | 1.086E+00 | 1.346E−01 | −6.137E−02 |
| B | 2.440E−03 | −5.781E−01 | −3.790E−01 | 7.407E−02 | 3.972E−02 | −8.848E−03 |
| C | 1.400E−05 | −2.662E−03 | 2.981E−02 | −3.187E−02 | −9.495E−03 | 3.977E−04 |
| D | −1.900E−05 | −6.365E−02 | −2.364E−02 | 1.641E−02 | −1.603E−03 | 2.723E−04 |
| E | 3.300E−05 | −2.300E−02 | 1.679E−03 | 2.210E−02 | −1.417E−04 | 2.900E−05 |
| F | −7.000E−06 | 1.650E−02 | 8.039E−04 | 9.031E−04 | 7.100E−05 | 0.000E+00 |
| G | 0.000E+00 | 1.599E−02 | 3.458E−03 | −1.191E−03 | 3.600E−05 | 0.000E+00 |
| H | 0.000E+00 | 5.559E−03 | 3.681E−03 | 9.218E−04 | −6.000E−06 | 0.000E+00 |

| | S9 | S10 | S11 | S12 | S13 |
|---|---|---|---|---|---|
| K | −2.167E+00 | 5.000E+01 | −6.189E+00 | −3.637E+00 | −3.290E+00 |
| A | −2.033E−01 | 1.255E−01 | 8.369E−02 | −3.518E−04 | 3.649E−02 |
| B | −3.269E−03 | −6.569E−03 | 5.254E−03 | −3.148E−03 | −1.233E−03 |
| C | 9.054E−04 | −1.409E−03 | −1.753E−03 | −3.240E−03 | −1.987E−03 |
| D | 2.421E−04 | 6.800E−05 | −8.200E−05 | −6.294E−04 | −8.443E−04 |
| E | 5.300E−05 | 2.400E−05 | 3.600E−05 | −6.800E−05 | −1.020E−04 |
| F | 0.000E+00 | 0.000E+00 | 0.000E+00 | 0.000E+00 | 0.000E+00 |
| G | 0.000E+00 | 0.000E+00 | 0.000E+00 | 0.000E+00 | 0.000E+00 |
| H | 0.000E+00 | 0.000E+00 | 0.000E+00 | 0.000E+00 | 0.000E+00 |

In addition, the optical imaging system 100 configured as described above may have the aberration characteristics illustrated in FIG. 6.

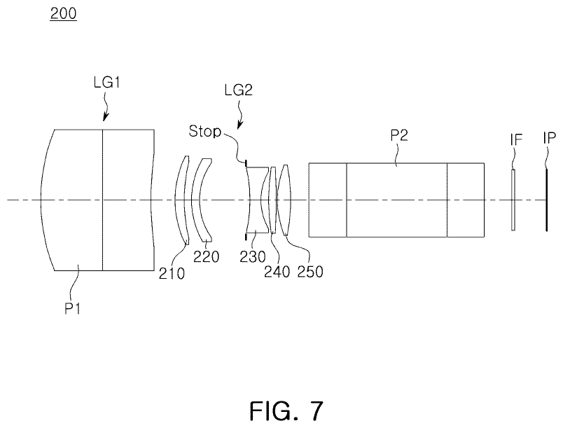

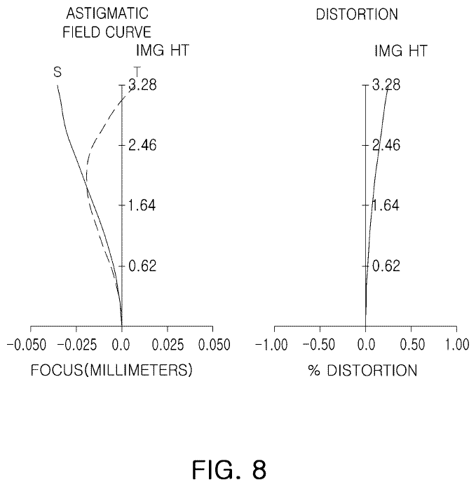

FIG. 7 is a configuration diagram of an optical imaging system according to a second embodiment of the present disclosure, and FIG. 8 is graphs illustrating aberration characteristics of the optical imaging system illustrated in FIG. 7.

An optical imaging system 200 according to a second embodiment of the present disclosure will be described with reference to FIGS. 7 and 8. FIG. 7 schematically illustrates an optical path of the optical imaging system 200 according to the second embodiment of the present disclosure in an unfolded state.

Referring to FIG. 7, an optical imaging system 200 according to the second embodiment of the present disclosure may include a first lens group LG1 and a second lens group LG2.

The first lens group LG1 may include a first reflective member P1, and the second lens group LG2 may include a first lens 210, a second lens 220, a third lens 230, a fourth lens 240, and a fifth lens 250 sequentially disposed in ascending numerical order along an optical axis of the second lens group LG2 from an object side of the second lens group LG2 toward an image side of the second lens group LG2.

The first reflective member P1 may include an incident surface PS1, a first reflective surface R1, and an exit surface PS2 as shown in FIG. 1.

The optical imaging system 200 may further include a second reflective member P2 disposed behind the second lens group LG2. The second reflective member P2 may include a second reflective surface R2 and a third reflective surface R3 as shown in FIG. 2.

In addition, the optical imaging system 200 may further include a filter IF and an imaging plane IP disposed after the second reflective member P2.

The imaging plane IP may refer to a surface on which a focal point is formed by the optical imaging system 200. For example, the imaging plane IP may refer to one surface of an image sensor IS on which light is received as shown in FIGS. 1 and 2.

A stop may be disposed between the second lens 220 and the third lens 230. For example, the stop may be disposed at an edge of an object-side surface of the third lens 230.

Characteristics of each element (a radius of curvature, a thickness of an element or a distance between elements, a refractive index, an Abbe number, and an effective radius) are listed in Table 3 below.

TABLE 3

| | Surface | Radius of | Thickness | Refractive | Abbe | Effective |
|---|---|---|---|---|---|---|
| Element | No. | Curvature | or Distance | Index | Number | Radius |
| First | S1 | 22.674 | 6.600 | 1.518 | 64.1 | 7.525 |
| Reflective | S2 | Infinity | 5.280 | 1.518 | 64.1 | 6.502 |
| Member | S3 | 41.111 | 2.479 | | | 5.399 |
| First | S4 | 9.849 | 1.017 | 1.547 | 55.9 | 4.650 |
| Lens | S5 | 35.581 | 0.882 | | | 4.579 |
| Second | S6 | 15.665 | 0.800 | 1.537 | 55.7 | 4.335 |
| Lens | S7 | 8.853 | 5.488 | | | 3.982 |
| Third | S8 (Stop) | −15.012 | 1.218 | 1.619 | 25.9 | 3.377 |
| Lens | S9 | 5.579 | 0.737 | | | 3.445 |
| Fourth | S10 | 35.824 | 0.800 | 1.678 | 19.2 | 3.502 |
| Lens | S11 | −26.769 | 0.100 | | | 3.535 |
| Fifth | S12 | 7.040 | 1.478 | 1.537 | 55.7 | 3.698 |
| Lens | S13 | −28.671 | 2.000 | | | 3.700 |
| Second | S14 | Infinity | 4.000 | 1.722 | 29.5 | 3.652 |
| Reflective | S15 | Infinity | 11.000 | 1.722 | 29.5 | 3.602 |
| Member | S16 | Infinity | 4.000 | 1.722 | 29.5 | 3.465 |
| | S17 | Infinity | 3.000 | | | 3.416 |
| Filter | S18 | Infinity | 0.210 | 1.519 | 64.2 | 3.351 |
| | S19 | Infinity | 3.389 | | | 3.348 |
| Imaging | S20 | Infinity | | | | 3.277 |
| Plane | | | | | | |

For reference, “Distance” in Table 3 may be based on a position of the second reflective member P2 when an object distance is infinity.

In the second embodiment of the present disclosure, the first reflective member P1 may have a positive refractive power, a paraxial region of the incident surface PS1 of the first reflective member P1 may have a convex shape, and a paraxial region of the exit surface PS2 of the first reflective member P1 may have a concave shape.

The first lens 210 may have a positive refractive power, a paraxial region of an object-side surface of the first lens 210 may have a convex shape, and a paraxial region of an image-side surface of the first lens 210 may have a concave shape.

The second lens 220 may have a negative refractive power, a paraxial region of an object-side surface of the second lens 220 may have a convex shape, and a paraxial region of an image-side surface of the second lens 220 may have a concave shape.

The third lens 230 may have a negative refractive power, and respective paraxial regions of an object-side surface and an image-side surface of the third lens 230 may each have a concave shape.

The fourth lens 240 may have a positive refractive power, and respective paraxial regions of an object-side surface and an image-side surface of the fourth lens 240 may each a convex shape.

The fifth lens 250 may have a positive refractive power, and respective paraxial regions of an object-side surface and an image-side surface of the fifth lens 250 may each have a convex shape.

One surface of the first reflective member P1 and both surfaces of each of the first lens 210 through the fifth lens 250 may have aspherical surface coefficients as listed in Table 4 below. For example, the incident surface PS1 of the first reflective member P1 may be an aspherical surface, the exit surface PS2 of the first reflective member P1 may be a spherical surface, and both the object-side surface and the image-side surface of each of the first lens 210 through the fifth lens 250 may be aspherical surfaces.

TABLE 4

| | S1 | S4 | S5 | S6 | S7 | S8 |
|---|---|---|---|---|---|---|
| K | −5.19E−02 | 1.37E−01 | 4.01E+01 | 6.69E+00 | 1.53E+00 | −8.58E−01 |
| A | 8.22E−02 | −1.05E+00 | 6.21E−02 | 1.01E+00 | 1.49E−01 | −1.57E−02 |
| B | 3.60E−03 | −4.97E−01 | −2.88E−01 | 8.24E−02 | 2.57E−02 | −8.15E−04 |
| C | −1.54E−04 | −1.95E−02 | 3.08E−02 | −2.94E−03 | 3.48E−04 | 8.52E−04 |
| D | −5.60E−05 | −5.89E−02 | −2.92E−02 | −6.62E−03 | −2.69E−03 | 1.70E−05 |
| E | 3.50E−05 | −1.34E−02 | −6.33E−03 | 1.06E−02 | −9.41E−04 | −8.00E−06 |
| F | −3.00E−06 | 1.43E−02 | −1.97E−03 | −4.00E−03 | 5.10E−04 | 0.00E+00 |
| G | 0.00E+00 | 6.84E−03 | −3.41E−03 | −5.73E−03 | 3.40E−05 | 0.00E+00 |
| H | 0.00E+00 | 2.23E−03 | 9.00E−04 | 2.97E−04 | 3.00E−06 | 0.00E+00 |

| | S9 | S10 | S11 | S12 | S13 |
|---|---|---|---|---|---|
| K | −1.63E+00 | 4.00E+01 | −8.23E+00 | −3.21E+00 | −1.02E+01 |
| A | −1.70E−01 | 1.13E−01 | 9.84E−02 | −3.73E−02 | −5.99E−03 |
| B | −2.81E−03 | −9.01E−03 | 7.65E−03 | −1.28E−02 | −1.46E−02 |
| C | 7.27E−04 | −1.61E−03 | −1.54E−03 | −4.06E−03 | −3.45E−03 |
| D | 1.96E−04 | 5.10E−05 | −1.24E−04 | −6.54E−04 | −8.84E−04 |
| E | 4.10E−05 | 2.70E−05 | 3.50E−05 | −6.00E−05 | −9.50E−05 |
| F | 0.00E+00 | 0.00E+00 | 0.00E+00 | 0.00E+00 | 0.00E+00 |
| G | 0.00E+00 | 0.00E+00 | 0.00E+00 | 0.00E+00 | 0.00E+00 |
| H | 0.00E+00 | 0.00E+00 | 0.00E+00 | 0.00E+00 | 0.00E+00 |

In addition, the optical imaging system 200 configured as described above may have the aberration characteristics illustrated in FIG. 8.

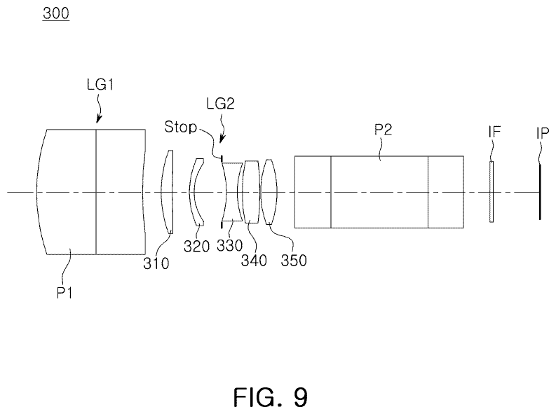

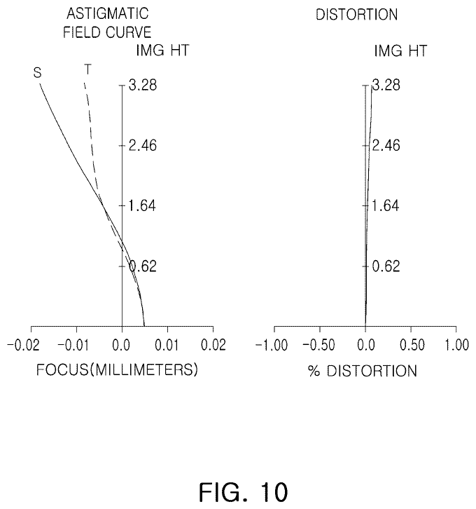

FIG. 9 is a configuration diagram of an optical imaging system according to a third embodiment of the present disclosure, and FIG. 10 is graphs illustrating aberration characteristics of the optical imaging system illustrated in FIG. 9.

An optical imaging system 300 according to a third embodiment of the present disclosure will be described with reference to FIGS. 9 and 10. FIG. 9 schematically illustrates an optical path of the optical imaging system 300 according to the third embodiment of the present disclosure in an unfolded state.

Referring to FIG. 9, and optical imaging system 300 according to the third embodiment of the present disclosure may include a first lens group LG1 and a second lens group LG2.

The first lens group LG1 may include a first reflective member P1, and the second lens group LG2 may include a first lens 310, a second lens 320, a third lens 330, a fourth lens 340, and a fifth lens 350 sequentially disposed in ascending numerical order along an optical axis of the second lens group LG2 from an object side of the second lens group LG2 toward an image side of the second lens group LG2.

The first reflective member P1 may include an incident surface PS1, a first reflective surface R1, and an exit surface PS2 as shown in FIG. 1.

The optical imaging system 300 may further include a second reflective member P2 disposed behind the second lens group LG2. The second reflective member P2 may include a second reflective surface R2 and a third reflective surface R3 as shown in FIG. 2.

In addition, the optical imaging system 300 may further include a filter IF and an imaging plane IP disposed after the second reflective member P2.

The imaging plane IP may refer to a surface on which a focal point is formed by the optical imaging system 300. For example, the imaging plane IP may refer to one surface of an image sensor IS on which light is received as shown in FIGS. 1 and 2.

A stop may be disposed between the second lens 320 and the third lens 330. For example, the stop may be disposed at an edge of an object-side surface of the third lens 330.

Characteristics of each element (a radius of curvature, a thickness of an element or a distance between elements, a refractive index, an Abbe number, and an effective radius) are listed in Table 5 below.

TABLE 5

| | Surface | Radius of | Thickness | Refractive | Abbe | Effective |
|---|---|---|---|---|---|---|
| Element | No. | Curvature | or Distance | Index | Number | Radius |
| First | S1 | 25.176 | 6.600 | 1.518 | 64.1 | 7.109 |
| Reflective | S2 | Infinity | 5.280 | 1.518 | 64.1 | 6.184 |
| Member | S3 | 60.000 | 2.000 | | | 5.264 |
| First | S4 | 11.444 | 1.204 | 1.608 | 59.9 | 4.700 |
| Lens | S5 | 152.354 | 2.061 | | | 4.640 |
| Second | S6 | 13.940 | 0.500 | 1.537 | 55.7 | 3.828 |
| Lens | S7 | 7.637 | 3.621 | | | 3.524 |
| Third | S8 (Stop) | −9.428 | 1.143 | 1.761 | 27.6 | 3.145 |
| Lens | S9 | 7.314 | 0.577 | | | 3.279 |
| Fourth | S10 | 39.084 | 1.951 | 1.678 | 19.2 | 3.354 |
| Lens | S11 | −29.100 | 0.100 | | | 3.539 |
| Fifth | S12 | 8.956 | 1.842 | 1.537 | 55.7 | 3.734 |
| Lens | S13 | −11.470 | 2.000 | | | 3.750 |
| Second | S14 | Infinity | 4.000 | 1.722 | 29.5 | 3.693 |
| Reflective | S15 | Infinity | 11.000 | 1.722 | 29.5 | 3.643 |
| Member | S16 | Infinity | 4.000 | 1.722 | 29.5 | 3.506 |
| | S17 | Infinity | 3.000 | | | 3.456 |
| Filter | S18 | Infinity | 0.210 | 1.519 | 64.2 | 3.392 |
| | S19 | Infinity | 5.204 | | | 3.389 |
| Imaging | S20 | Infinity | | | | 3.277 |
| Plane | | | | | | |

For reference, “Distance” in Table 5 may be based on a position of the second reflective member P2 when an object distance is infinity.

In the third embodiment of the present disclosure, the first reflective member P1 may have a positive refractive power, a paraxial region of the incident surface PS1 of the first reflective member P1 may have a convex shape, and a paraxial region of the exit surface PS2 of the first reflective member P1 may have a concave shape.

The first lens 310 may have a positive refractive power, a paraxial region of an object-side surface of the first lens 310 may have a convex shape, and a paraxial region of an image-side surface of the first lens 310 may have a concave shape.

The second lens 320 may have a negative refractive power, a paraxial region of an object-side surface of the second lens 320 may have a convex shape, and a paraxial region of an image-side surface of the second lens 320 may have a concave shape.

The third lens 330 may have a negative refractive power, and respective paraxial regions of an object-side surface and an image-side surface of the third lens 330 may each have a concave shape.

The fourth lens 340 may have a positive refractive power, and respective paraxial regions of an object-side surface and an image-side surface of the fourth lens 340 may each have a convex shape.

The fifth lens 350 may have a positive refractive power, and respective paraxial regions of an object-side surface and an image-side surface of the fifth lens 350 may each have a convex shape.

One surface of the first reflective member P1 and both surfaces of each of the first lens 310 through the fifth lens 350 may have aspherical surface coefficients as listed in Table 6 below. For example, the incident surface PS1 of the first reflective member P1 may be an aspherical surface, the exit surface PS2 of the first reflective member P1 may be a spherical surface, and both the object-side surface and the image-side surface of each of the first lens 310 through the fifth lens 350 may be aspherical surfaces.

TABLE 6

| | S1 | S4 | S5 | S6 | S7 | S8 |
|---|---|---|---|---|---|---|
| K | −1.47E−01 | 1.19E−01 | 1.68E+01 | 6.51E+00 | 6.86E−01 | −6.75E−01 |
| A | 3.34E−02 | −1.14E+00 | −1.57E−01 | 9.49E−01 | 1.65E−01 | 2.21E−03 |
| B | 7.20E−04 | −4.84E−01 | −1.37E−01 | 1.92E−01 | 3.42E−02 | −5.93E−03 |
| C | −2.14E−04 | −1.05E−01 | −5.43E−03 | 1.28E−02 | −4.73E−03 | −1.41E−04 |
| D | −5.00E−06 | −2.86E−02 | −4.41E−03 | −3.89E−03 | 2.74E−03 | 1.30E−04 |
| E | −2.00E−06 | −7.25E−03 | −2.58E−04 | −6.43E−03 | 2.90E−04 | 2.00E−05 |
| F | −1.00E−06 | −2.41E−03 | −3.43E−04 | 6.19E−03 | 6.00E−06 | 0.00E+00 |
| G | 0.00E+00 | −8.40E−04 | −1.88E−04 | 2.49E−04 | 1.60E−05 | 0.00E+00 |
| H | 0.00E+00 | −2.69E−04 | −1.51E−04 | −6.78E−04 | 1.50E−05 | 0.00E+00 |

| | S9 | S10 | S11 | S12 | S13 |
|---|---|---|---|---|---|
| K | −8.42E−01 | 2.22E+01 | −2.25E+01 | −3.31E+00 | −4.32E−02 |
| A | −1.05E−01 | 9.89E−02 | 6.31E−02 | −4.02E−02 | −1.07E−02 |
| B | −4.62E−03 | 1.44E−03 | 9.95E−03 | −2.16E−03 | −6.18E−03 |
| C | −6.40E−05 | −5.66E−04 | 1.06E−03 | −3.25E−04 | −7.54E−04 |
| D | 9.20E−05 | 1.38E−04 | 2.43E−04 | −1.80E−05 | −1.22E−04 |
| E | 2.30E−05 | 3.60E−05 | 4.70E−05 | −8.00E−06 | −3.30E−05 |
| F | 0.00E+00 | 0.00E+00 | 0.00E+00 | 0.00E+00 | 0.00E+00 |
| G | 0.00E+00 | 0.00E+00 | 0.00E+00 | 0.00E+00 | 0.00E+00 |
| H | 0.00E+00 | 0.00E+00 | 0.00E+00 | 0.00E+00 | 0.00E+00 |

In addition, the optical imaging system 300 configured as described above may have the aberration characteristics illustrated in FIG. 10.

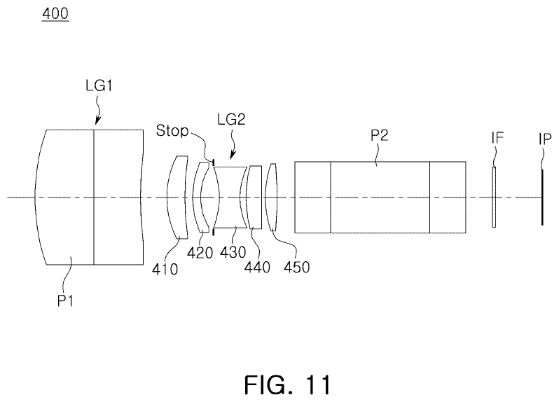

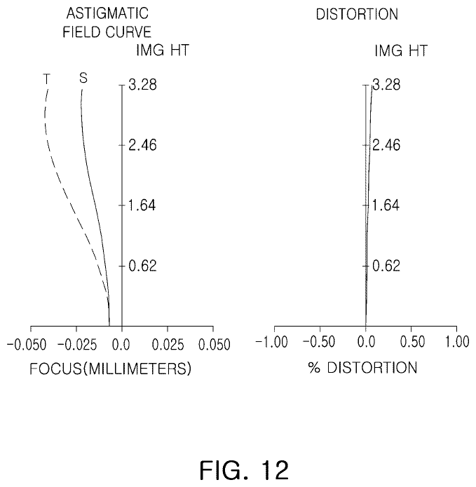

FIG. 11 is a configuration diagram of an optical imaging system according to a fourth embodiment of the present disclosure, and FIG. 12 is graphs illustrating aberration characteristics of the optical imaging system illustrated in FIG. 11.

An optical imaging system 400 according to a fourth embodiment of the present disclosure will be described with reference to FIGS. 11 and 12. FIG. 11 schematically illustrates an optical path of the optical imaging system 400 according to the fourth embodiment of the present disclosure in an unfolded state.

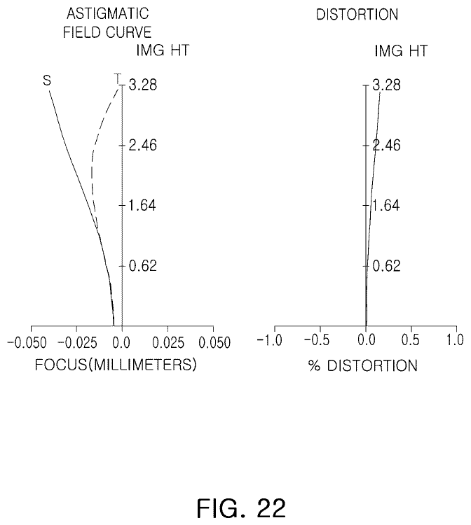

Referring to FIG. 22, the optical imaging system 400 according to a fourth embodiment of the present disclosure may include a first lens group LG1 and a second lens group LG2.

The first lens group LG1 may include a first reflective member P1, and the second lens group LG2 may include a first lens 410, a second lens 420, a third lens 430, a fourth lens 440, and a fifth lens 450 sequentially disposed in ascending numerical order along an optical axis of the second lens group LG2 from an object side of the second lens group LG2 toward an image side of the second lens group LG2.

The first reflective member P1 may include an incident surface PS1, a first reflective surface R1, and an exit surface PS2 as shown in FIG. 1.

The optical imaging system 400 may further include a second reflective member P2 disposed behind the second lens group LG2. The second reflective member P2 may include a second reflective surface R2 and a third reflective surface R3 as shown in FIG. 2.

In addition, the optical imaging system 400 may further include a filter IF and an imaging plane IP disposed after the second reflective member P2.

The imaging plane IP may refer to a surface on which a focal point is formed by the optical imaging system 400. For example, the imaging plane IP may refer to one surface of an image sensor IS on which light is received as shown in FIGS. 1 and 2.

A stop may be disposed between the second lens 420 and the third lens 430. For example, the stop may be disposed at an edge of an object-side surface of the third lens 430.

Characteristics of each element (a radius of curvature, a thickness of an element or a distance between elements, a refractive index, an Abbe number, and an effective radius) are listed in Table 7 below.

TABLE 7

| | Surface | Radius of | Thickness | Refractive | Abbe | Effective |
|---|---|---|---|---|---|---|
| Element | No. | Curvature | or Distance | Index | Number | Radius |
| First | S1 | 22.994 | 6.600 | 1.518 | 64.1 | 7.609 |
| Reflective | S2 | Infinity | 5.280 | 1.518 | 64.1 | 6.613 |
| Member | S3 | 60.000 | 2.848 | | | 5.563 |
| First | S4 | 10.941 | 2.000 | 1.598 | 39.3 | 4.700 |
| Lens | S5 | 66.388 | 0.889 | | | 4.443 |
| Second | S6 | 13.915 | 0.800 | 1.537 | 55.7 | 3.937 |
| Lens | S7 | 7.965 | 2.089 | | | 3.516 |
| Third | S8 (Stop) | −9.396 | 2.387 | 1.635 | 23.3 | 3.391 |
| Lens | S9 | 6.589 | 0.570 | | | 3.550 |
| Fourth | S10 | 24.352 | 1.899 | 1.678 | 19.2 | 3.611 |
| Lens | S11 | −24.414 | 0.231 | | | 3.656 |
| Fifth | S12 | 9.937 | 1.287 | 1.622 | 60.4 | 3.767 |
| Lens | S13 | −36.577 | 2.000 | | | 3.750 |
| Second | S14 | Infinity | 4.000 | 1.722 | 29.5 | 3.701 |
| Reflective | S15 | Infinity | 11.000 | 1.722 | 29.5 | 3.650 |
| Member | S16 | Infinity | 4.000 | 1.722 | 29.5 | 3.510 |
| | S17 | Infinity | 3.000 | | | 3.459 |
| Filter | S18 | Infinity | 0.210 | 1.519 | 64.2 | 3.393 |
| | S19 | Infinity | 5.297 | | | 3.390 |
| Imaging | S20 | Infinity | | | | 3.277 |
| Plane | | | | | | |

For reference, “Distance” in Table 7 may be based on a position of the second reflective member P2 when an object distance is infinity.

In the fourth embodiment of the present disclosure, the first reflective member P1 may have a positive refractive power, a paraxial region of the incident surface PS1 of the first reflective member P1 may have a convex shape, and a paraxial region of the exit surface PS2 of the first reflective member P1 may have a concave shape.

The first lens 410 may have a positive refractive power, a paraxial region of an object-side surface of the first lens 410 may have a convex shape, and a paraxial region of an image-side surface of the first lens 410 may have a concave shape.

The second lens 420 may have a negative refractive power, a paraxial region of an object-side surface of the second lens 420 may have a convex shape, and a paraxial region of an image-side surface of the second lens 420 may have a concave shape.

The third lens 430 may have a negative refractive power, and respective paraxial regions of an object-side surface and an image-side surface of the third lens 430 may each have a concave shape.

The fourth lens 440 may have a positive refractive power, and respective paraxial regions of an object-side surface and an image-side surface of the fourth lens 440 may each have a convex shape.

The fifth lens 450 may have a positive refractive power, and respective paraxial regions of an object-side surface and an image-side surface of the fifth lens 450 may each have a convex shape.

One surface of the first reflective member P1 and both surfaces of each of the first lens 410 through the fifth lens 450 may have aspherical surface coefficients as listed in Table 8 below. For example, the incident surface PS1 of the first reflective member P1 may be an aspherical surface, the exit surface PS2 of the first reflective member P1 may be a spherical surface, and both the object-side surface and the image-side surface of each of the first lens 410 through the fifth lens 450 may be aspherical surfaces.

TABLE 8

| | S1 | S4 | S5 | S6 | S7 | S8 |
|---|---|---|---|---|---|---|
| K | −2.28E−02 | 1.34E−01 | 2.73E+01 | 6.20E+00 | 6.69E−01 | −7.49E−01 |
| A | 4.91E−02 | −1.14E+00 | −1.62E−01 | 9.09E−01 | 1.63E−01 | −2.68E−03 |
| B | 2.46E−03 | −4.79E−01 | −1.45E−01 | 2.08E−01 | 3.53E−02 | −9.20E−03 |
| C | 1.44E−04 | −1.09E−01 | −2.54E−03 | 6.15E−03 | −3.07E−03 | 2.26E−04 |
| D | 2.50E−05 | −2.85E−02 | −2.68E−03 | −4.19E−03 | 4.06E−03 | 3.62E−04 |
| E | −2.00E−06 | −6.64E−03 | −3.49E−04 | −5.65E−03 | 1.08E−03 | 5.00E−05 |
| F | −1.00E−06 | −2.16E−03 | −9.10E−04 | 6.10E−03 | 1.07E−04 | 0.00E+00 |
| G | 0.00E+00 | −8.68E−04 | −4.67E−04 | −2.70E−05 | 3.80E−05 | 0.00E+00 |
| H | 0.00E+00 | −4.84E−04 | −4.83E−04 | −1.42E−03 | −2.00E−06 | 0.00E+00 |

| | S9 | S10 | S11 | S12 | S13 |
|---|---|---|---|---|---|
| K | −8.43E−01 | 2.13E+01 | −1.69E+01 | −2.94E+00 | 1.34E+01 |
| A | −1.52E−01 | 1.22E−01 | 9.05E−02 | −3.82E−02 | −1.84E−02 |
| B | −8.91E−03 | −1.46E−03 | 1.81E−02 | −2.74E−03 | −6.69E−03 |
| C | −4.64E−04 | −9.88E−04 | 2.45E−03 | −4.38E−04 | −9.13E−04 |
| D | 1.60E−04 | 3.74E−04 | 4.75E−04 | −5.50E−05 | −1.24E−04 |
| E | 4.90E−05 | 8.60E−05 | 7.40E−05 | −1.40E−05 | −3.10E−05 |
| F | 0.00E+00 | 0.00E+00 | 0.00E+00 | 0.00E+00 | 0.00E+00 |
| G | 0.00E+00 | 0.00E+00 | 0.00E+00 | 0.00E+00 | 0.00E+00 |
| H | 0.00E+00 | 0.00E+00 | 0.00E+00 | 0.00E+00 | 0.00E+00 |

In addition, the optical imaging system 400 configured as described above may have the aberration characteristics illustrated in FIG. 12.

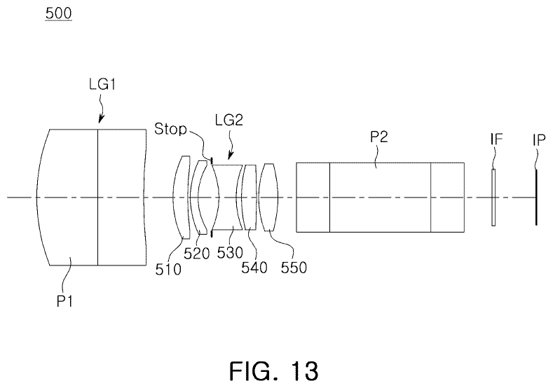

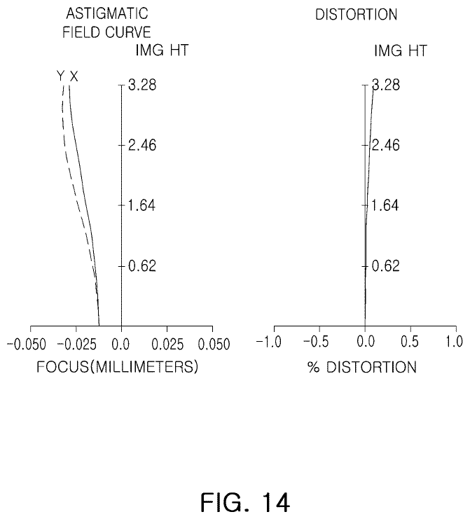

FIG. 13 is a configuration diagram of an optical imaging system according to a fifth embodiment of the present disclosure, and FIG. 14 is graphs illustrating aberration characteristics of the optical imaging system illustrated in FIG. 13.

An optical imaging system 500 according to a fifth embodiment of the present disclosure will be described with reference to FIGS. 13 and 14. FIG. 13 schematically illustrates an optical path of the optical imaging system 500 according to the fifth embodiment of the present disclosure in an unfolded state.

Referring to FIG. 13, the optical imaging system 500 according to the fifth embodiment of the present disclosure may include a first lens group LG1 and a second lens group LG2.

The first lens group LG1 may include a first reflective member P1, and the second lens group LG2 may include a first lens 510, a second lens 520, a third lens 530, a fourth lens 540, and a fifth lens sequentially disposed in ascending numerical order along an optical axis of the second lens group LG2 from an object side of the second lens group LG2 toward an image side of the second lens group LG2.

The first reflective member P1 may include an incident surface PS1, a first reflective surface R1, and an exit surface PS2 as shown in FIG. 1.

The optical imaging system 500 may further include a second reflective member P2 disposed behind the second lens group LG2. The second reflective member P2 may include a second reflective surface R2 and a third reflective surface R3 as shown in FIG. 2.

In addition, the optical imaging system 500 may further include a filter IF and an imaging plane IP disposed after the second reflective member P2.

The imaging plane IP may refer to a surface on which a focal point is formed by the optical imaging system 500. For example, the imaging plane IP may refer to one surface of an image sensor IS on which light is received as shown in FIGS. 1 and 2.

A stop may be disposed between the second lens 520 and the third lens 530. For example, the stop may be disposed at an edge of an object-side surface of the third lens 530.

Characteristics of each element (a radius of curvature, a thickness of an element or a distance between elements, a refractive index, an Abbe number, and an effective radius) are listed in Table 9 below.

TABLE 9

| | Surface | Radius of | Thickness | Refractive | Abbe | Effective |
|---|---|---|---|---|---|---|
| Element | No. | Curvature | or Distance | Index | Number | Radius |
| First | S1 | 23.455 | 6.600 | 1.518 | 64.1 | 7.666 |
| Reflective | S2 | Infinity | 5.280 | 1.518 | 64.1 | 6.681 |
| Member | S3 | 60.000 | 3.288 | | | 5.644 |
| First | S4 | 11.046 | 1.691 | 1.735 | 44.7 | 4.700 |
| Lens | S5 | 63.830 | 0.284 | | | 4.504 |
| Second | S6 | 13.550 | 0.800 | 1.634 | 35.3 | 4.126 |
| Lens | S7 | 8.644 | 2.297 | | | 3.692 |
| Third | S8 (Stop) | −8.689 | 2.000 | 1.652 | 33.8 | 3.531 |
| Lens | S9 | 6.761 | 0.607 | | | 3.585 |
| Fourth | S10 | 28.722 | 1.674 | 1.748 | 28.1 | 3.639 |
| Lens | S11 | −41.560 | 0.125 | | | 3.652 |
| Fifth | S12 | 8.761 | 2.232 | 1.518 | 67.5 | 3.764 |
| Lens | S13 | −18.239 | 2.000 | | | 3.750 |
| Second | S14 | Infinity | 4.000 | 1.722 | 29.5 | 3.696 |
| Reflective | S15 | Infinity | 11.000 | 1.722 | 29.5 | 3.644 |
| Member | S16 | Infinity | 4.000 | 1.722 | 29.5 | 3.502 |
| | S17 | Infinity | 3.000 | | | 3.451 |
| Filter | S18 | Infinity | 0.210 | 1.519 | 64.2 | 3.384 |
| | S19 | Infinity | 4.871 | | | 3.381 |
| Imaging | S20 | Infinity | | | | 3.277 |
| Plane | | | | | | |

For reference, “Distance” in Table 9 may be based on a position of the second reflective member P2 when an object distance is infinity.

In the fifth embodiment of the present disclosure, the first reflective member P1 may have a positive refractive power, a paraxial region of the incident surface PS1 of the first reflective member P1 may have a convex shape, and a paraxial region of the exit surface PS2 of the first reflective member P1 may have a concave shape.

The first lens 510 may have a positive refractive power, a paraxial region of an object-side surface of the first lens 510 may have a convex shape, and a paraxial region of an image-side surface of the first lens 510 may have a concave shape.

The second lens 520 may have a negative refractive power, a paraxial region of an object-side surface of the second lens 520 may have a convex shape, and a paraxial region of an image-side surface of the second lens 520 may have a concave shape.

The third lens 530 may have a negative refractive power, and respective paraxial regions of an object-side surface and an image-side surface of the third lens 530 may each have a concave shape.

The fourth lens 540 may have a positive refractive power, and respective paraxial regions of an object-side surface and an image-side surface of the fourth lens 540 may each have a convex shape.

The fifth lens 550 may have a positive refractive power, and respective paraxial regions of an object-side surface and an image-side surface of the fifth lens 550 may each have a convex shape.

One surface of the first reflective member P1 and both surfaces of each of the first lens 510 through the fifth lens 550 may have aspherical surface coefficients as listed in Table 10 below. For example, the incident surface PS1 of the first reflective member P1 may be an aspherical surface, the exit surface PS2 of the first reflective member P1 may be a spherical surface, and both the object-side surface and the image-side surface of each of the first lens 510 through the fifth lens 550 may be aspherical surfaces.

TABLE 10

| | S1 | S4 | S5 | S6 | S7 | S8 |
|---|---|---|---|---|---|---|
| K | −1.02E−01 | 1.04E−01 | 3.59E+01 | 6.29E+00 | 6.18E−01 | −8.21E−01 |
| A | 4.28E−02 | −1.15E+00 | −1.56E−01 | 9.28E−01 | 1.59E−01 | 8.25E−03 |
| B | 2.93E−03 | −4.78E−01 | −1.47E−01 | 1.98E−01 | 3.58E−02 | −5.46E−03 |
| C | 3.89E−04 | −1.10E−01 | 5.54E−04 | 1.53E−02 | 9.70E−05 | 2.11E−03 |
| D | −6.00E−06 | −2.87E−02 | −6.99E−03 | −8.92E−03 | 5.93E−03 | 8.13E−04 |
| E | 1.10E−05 | −4.98E−03 | 2.41E−03 | −2.88E−03 | 1.09E−03 | 9.50E−05 |
| F | 2.00E−06 | −3.53E−03 | −1.42E−03 | 5.25E−03 | 3.95E−04 | 0.00E+00 |
| G | 0.00E+00 | −2.23E−03 | −1.24E−03 | −6.04E−04 | 1.21E−04 | 0.00E+00 |
| H | 0.00E+00 | −6.29E−04 | 1.45E−04 | 4.62E−04 | 2.50E−05 | 0.00E+00 |

| | S9 | S10 | S11 | S12 | S13 |
|---|---|---|---|---|---|
| K | −8.68E−01 | 2.10E+01 | −5.00E+01 | −3.49E+00 | 3.37E+00 |
| A | −1.56E−01 | 1.30E−01 | 1.08E−01 | −4.10E−02 | −9.16E−03 |
| B | −6.80E−03 | 1.31E−03 | 1.89E−02 | −2.90E−03 | −9.09E−03 |
| C | 4.63E−04 | −1.20E−04 | 2.37E−03 | −8.26E−04 | −1.27E−03 |
| D | 3.60E−04 | 5.71E−04 | 4.00E−04 | −1.27E−04 | −1.63E−04 |
| E | 7.00E−05 | 1.05E−04 | 6.60E−05 | −2.00E−05 | −3.20E−05 |
| F | 0.00E+00 | 0.00E+00 | 0.00E+00 | 0.00E+00 | 0.00E+00 |
| G | 0.00E+00 | 0.00E+00 | 0.00E+00 | 0.00E+00 | 0.00E+00 |
| H | 0.00E+00 | 0.00E+00 | 0.00E+00 | 0.00E+00 | 0.00E+00 |

In addition, the optical imaging system 500 configured as described above may have the aberration characteristics illustrated in FIG. 14.

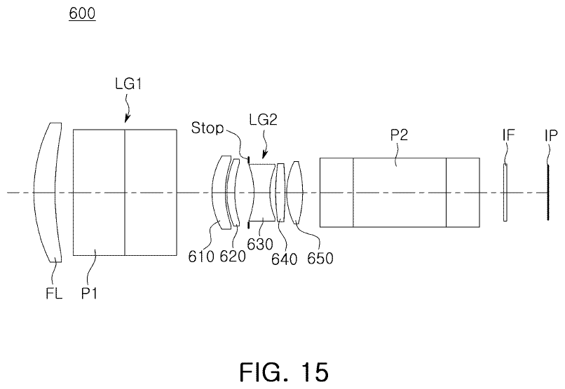

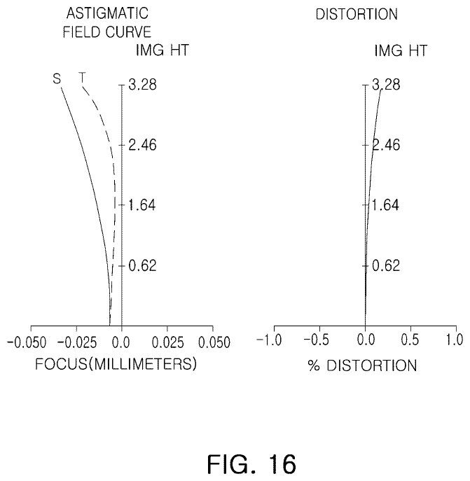

FIG. 15 is a configuration diagram of an optical imaging system according to a sixth embodiment of the present disclosure, and FIG. 16 is graphs illustrating aberration characteristics of the optical imaging system illustrated in FIG. 15.

An optical imaging system 600 according to a sixth embodiment of the present disclosure will be described with reference to FIGS. 15 and 16. FIG. 15 schematically illustrates an optical path of the optical imaging system 600 according to the sixth embodiment of the present disclosure in an unfolded state.

Referring to FIG. 15, the optical imaging system 600 according to the sixth embodiment of the present disclosure may include a first lens group LG1 and a second lens group LG2.

The first lens group LG1 may include a front lens FL and a first reflective member P1, and the second lens group LG2 may include a first lens 610, a second lens 620, a third lens 630, a fourth lens 640, and a fifth lens 650 sequentially disposed in ascending numerical order along an optical axis of the second lens group LG2 from an object side of the second lens group LG2 toward an image side of the second lens group LG2.

The front lens FL may be disposed in front of the first reflective member P1.

The first reflective member P1 may include an incident surface PS1, a first reflective surface R1, and an exit surface PS2 as shown in FIG. 3.

The optical imaging system 600 may further include a second reflective member P2 disposed behind the second lens group LG2. The second reflective member P2 may include a second reflective surface R2 and a third reflective surface R3 as shown in FIG. 4.

In addition, the optical imaging system 600 may further include a filter IF and an imaging plane IP disposed after the second reflective member P2.

The imaging plane IP may refer to a surface on which a focal point is formed by the optical imaging system 600. For example, the imaging plane IP may refer to one surface of an image sensor IS on which light is received as shown in FIGS. 3 and 4.

A stop may be disposed between the second lens 620 and the third lens 630. For example, the stop may be disposed at an edge of an object-side surface of the third lens 630.

Characteristics of each element (a radius of curvature, a thickness of an element or a distance between elements, a refractive index, an Abbe number, and an effective radius) are listed in Table 11 below.

TABLE 11

| | Surface | Radius of | Thickness | Refractive | Abbe | Effective |
|---|---|---|---|---|---|---|
| Element | No. | Curvature | or Distance | Index | Number | Radius |
| Front | S1 | 20.879 | 2.500 | 1.546 | 56.0 | 8.292 |
| Lens | S2 | 47.642 | 2.000 | | | 7.984 |
| First | S3 | Infinity | 6.200 | 1.518 | 64.1 | 7.655 |
| Reflective | S4 | Infinity | 6.200 | 1.518 | 64.1 | 6.659 |
| Member | S5 | Infinity | 4.172 | | | 5.664 |
| First | S6 | 9.507 | 1.734 | 1.547 | 55.9 | 4.350 |
| Lens | S7 | 35.790 | 0.142 | | | 4.080 |
| Second | S8 | 17.773 | 0.800 | 1.537 | 55.7 | 3.974 |
| Lens | S9 | 13.467 | 2.366 | | | 3.703 |
| Third | S10 (Stop) | −11.295 | 1.794 | 1.694 | 31.2 | 3.303 |
| Lens | S11 | 5.643 | 0.807 | | | 3.394 |
| Fourth | S12 | 172.915 | 1.073 | 1.678 | 19.2 | 3.454 |
| Lens | S13 | −33.982 | 0.213 | | | 3.533 |
| Fifth | S14 | 7.554 | 1.899 | 1.537 | 55.7 | 3.711 |
| Lens | S15 | −12.599 | 2.000 | | | 3.700 |
| Second | S16 | Infinity | 4.000 | 1.722 | 29.5 | 3.651 |
| Reflective | S17 | Infinity | 11.000 | 1.722 | 29.5 | 3.605 |
| Member | S18 | Infinity | 4.000 | 1.722 | 29.5 | 3.480 |
| | S19 | Infinity | 3.000 | | | 3.434 |
| Filter | S20 | Infinity | 0.210 | 1.519 | 64.2 | 3.375 |
| | S21 | Infinity | 4.989 | | | 3.372 |
| Imaging | S22 | Infinity | | | | 3.277 |
| Plane | | | | | | |

For reference, “Distance” in Table 11 may be based on a position of the second reflective member P2 when an object distance is infinity.

In the sixth embodiment of the present disclosure, the front lens FL may have a positive refractive power, a paraxial region of an object-side surface of the front lens FL may have a convex shape, and a paraxial region of an image-side surface of the front lens FL may have a concave shape.

The first lens 610 may have a positive refractive power, a paraxial region of an object-side surface of the first lens 610 may have a convex shape, and a paraxial region of an image-side surface of the first lens 610 may have a concave shape.

The second lens 620 may have a negative refractive power, a paraxial region of an object-side surface of the second lens 620 may have a convex shape, and a paraxial region of an image-side surface of the second lens 620 may have a concave shape.

The third lens 630 may have a negative refractive power, and respective paraxial regions of an object-side surface and an image-side surface of the third lens 630 may each have a concave shape.

The fourth lens 640 may have a positive refractive power, and respective paraxial regions of an object-side surface and an image-side surface of the fourth lens 640 may each have a convex shape.

The fifth lens 650 may have a positive refractive power, and respective paraxial regions of an object-side surface and an image-side surface of the fifth lens 650 may each have a convex shape.

One surface of the front lens FL and both surfaces of each of the first lens 610 through the fifth lens 650 may have aspherical surface coefficients as listed in Table 12 below. For example, the object-side surface of the front lens FL may be an aspherical surface, the image-side surface of the front lens FL may be a spherical surface, and both the object-side surface and the image-side surface of each of the first lens 610 through the fifth lens 650 may be aspherical surfaces.

TABLE 12

| | S1 | S6 | S7 | S8 | S9 | S10 |
|---|---|---|---|---|---|---|
| K | 0.00E+00 | 3.31E−01 | 4.04E+01 | 6.32E+00 | −2.79E−01 | 1.89E+00 |
| A | 5.31E−02 | −1.06E+00 | 8.13E−02 | 1.09E+00 | 1.29E−01 | −5.68E−02 |
| B | 3.03E−03 | −5.62E−01 | −3.84E−01 | 7.83E−02 | 4.23E−02 | −9.20E−03 |
| C | 1.00E−04 | −3.27E−02 | 3.80E−02 | −3.26E−02 | −1.20E−02 | 8.40E−05 |
| D | 2.20E−05 | −4.92E−02 | −2.60E−02 | 1.26E−02 | −3.83E−03 | 2.03E−04 |
| E | 9.00E−06 | −2.60E−02 | −1.82E−03 | 2.65E−02 | −9.38E−04 | 2.30E−05 |
| F | 0.00E+00 | 1.45E−02 | 2.80E−03 | 3.41E−04 | 2.38E−04 | 0.00E+00 |
| G | 0.00E+00 | 1.48E−02 | 5.88E−03 | −2.15E−03 | 9.20E−05 | 0.00E+00 |
| H | 0.00E+00 | 3.46E−03 | 2.56E−03 | 6.10E−04 | 2.30E−05 | 0.00E+00 |

| | S11 | S12 | S13 | S14 | S15 |
|---|---|---|---|---|---|
| K | −2.21E+00 | −3.40E+01 | −9.78E+00 | −3.46E+00 | −3.69E+00 |
| A | −1.93E−01 | 1.27E−01 | 8.33E−02 | 2.44E−03 | 3.86E−02 |
| B | −1.44E−03 | −4.74E−03 | 4.80E−03 | −3.36E−03 | −1.01E−03 |
| C | 1.25E−03 | −9.44E−04 | −1.89E−03 | −3.27E−03 | −1.91E−03 |
| D | 2.85E−04 | 1.23E−04 | −1.18E−04 | −6.34E−04 | −8.22E−04 |
| E | 5.30E−05 | 2.70E−05 | 3.20E−05 | −6.80E−05 | −9.90E−05 |
| F | 0.00E+00 | 0.00E+00 | 0.00E+00 | 0.00E+00 | 0.00E+00 |
| G | 0.00E+00 | 0.00E+00 | 0.00E+00 | 0.00E+00 | 0.00E+00 |
| H | 0.00E+00 | 0.00E+00 | 0.00E+00 | 0.00E+00 | 0.00E+00 |

In addition, the optical imaging system 600 configured as described above may have the aberration characteristics illustrated in FIG. 16.

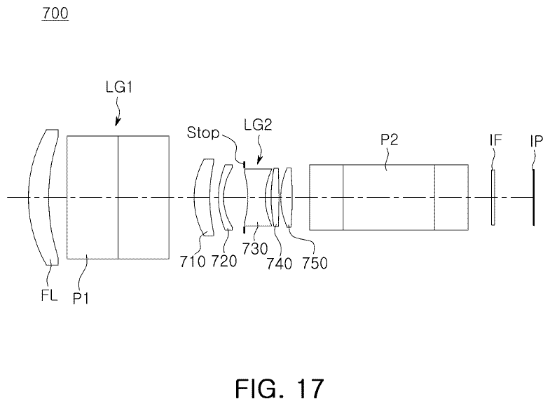

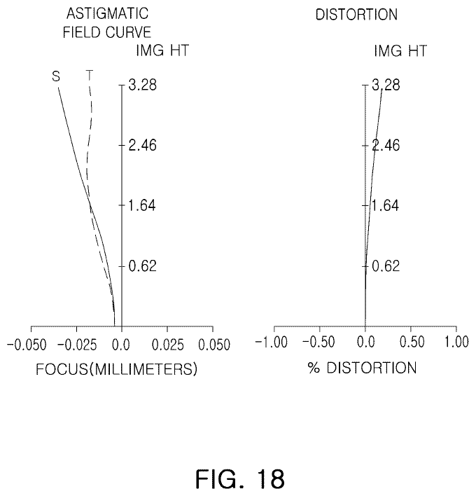

FIG. 17 is a configuration diagram of an optical imaging system according to a seventh embodiment of the present disclosure, and FIG. 18 is graphs illustrating aberration characteristics of the optical imaging system illustrated in FIG. 17.

An optical imaging system 700 according to a seventh embodiment of the present disclosure will be described with reference to FIGS. 17 and 18. FIG. 17 schematically illustrates an optical path of the optical imaging system 700 according to the seventh embodiment of the present disclosure in an unfolded state.

Referring to FIG. 17, the optical imaging system 700 according to the seventh embodiment of the present disclosure may include a first lens group LG1 and a second lens group LG2.

The first lens group LG1 may include a front lens FL and a first reflective member P1, and the second lens group LG2 may include a first lens 710, a second lens 720, a third lens 730, a fourth lens 740, and a fifth lens sequentially disposed in ascending numerical order along an optical axis of the second lens group LG2 from an object side of the second lens group LG2 toward an image side of the second lens group LG2.

The front lens FL may be disposed in front of the first reflective member P1.

The first reflective member P1 may include an incident surface PS1, a first reflective surface R1, and an exit surface PS2 as shown in FIG. 3.

The optical imaging system 700 may further include a second reflective member P2 disposed behind the second lens group LG2. The second reflective member P2 may include a second reflective surface R2 and a third reflective surface R3 as shown in FIG. 4.

In addition, the optical imaging system 700 may further include a filter IF and an imaging plane IP disposed after the second reflective member P2.

The imaging plane IP may refer to a surface on which a focal point is formed by the optical imaging system 700. For example, the imaging plane IP may refer to one surface of an image sensor IS on which light is received as shown in FIGS. 3 and 4.

A stop may be disposed between the second lens 720 and the third lens 730. For example, the stop may be disposed at an edge of an object-side surface of the third lens 730.

Characteristics of each element (a radius of curvature, a thickness of an element or a distance between elements, a refractive index, an Abbe number, and an effective radius) are listed in Table 13 below.

TABLE 13

| | Surface | Radius of | Thickness | Refractive | Abbe | Effective |
|---|---|---|---|---|---|---|
| Element | No. | Curvature | or Distance | Index | Number | Radius |
| Front | S1 | 17.358 | 2.500 | 1.548 | 53.9 | 8.167 |
| Lens | S2 | 27.260 | 2.000 | | | 7.773 |
| First | S3 | Infinity | 6.200 | 1.518 | 64.1 | 7.572 |
| Reflective | S4 | Infinity | 6.200 | 1.518 | 64.1 | 6.613 |
| Member | S5 | Infinity | 3.054 | | | 5.655 |
| First | S6 | 9.732 | 1.901 | 1.547 | 55.9 | 4.650 |
| Lens | S7 | 34.950 | 1.000 | | | 4.383 |
| Second | S8 | 15.723 | 0.588 | 1.537 | 55.7 | 4.071 |
| Lens | S9 | 8.974 | 3.021 | | | 3.795 |
| Third | S10 (Stop) | −15.003 | 2.000 | 1.619 | 25.9 | 3.510 |
| Lens | S11 | 5.567 | 0.747 | | | 3.523 |
| Fourth | S12 | 35.909 | 0.967 | 1.678 | 19.2 | 3.575 |
| Lens | S13 | −28.707 | 0.209 | | | 3.603 |
| Fifth | S14 | 7.541 | 1.486 | 1.537 | 55.7 | 3.712 |
| Lens | S15 | −24.560 | 2.000 | | | 3.700 |
| Second | S16 | Infinity | 4.000 | 1.722 | 29.5 | 3.654 |
| Reflective | S17 | Infinity | 11.000 | 1.722 | 29.5 | 3.608 |
| Member | S18 | Infinity | 4.000 | 1.722 | 29.5 | 3.480 |
| | S19 | Infinity | 3.000 | | | 3.433 |
| Filter | S20 | Infinity | 0.210 | 1.519 | 64.2 | 3.373 |
| | S21 | Infinity | 4.791 | | | 3.370 |
| Imaging | S22 | Infinity | | | | 3.277 |
| Plane | | | | | | |

For reference, “Distance” in Table 13 may be based on a position of the second reflective member P2 when an object distance is infinity.

In the seventh embodiment of the present disclosure, the front lens FL may have a positive refractive power, a paraxial region of an object-side surface of the front lens FL may have a convex shape, and a paraxial region of an image-side surface of the front lens FL may have a concave shape.

The first lens 710 may have a positive refractive power, a paraxial region of an object-side surface of the first lens 710 may have a convex shape, and a paraxial region of an image-side surface of the first lens 710 may have a concave shape.

The second lens 720 may have a negative refractive power, a paraxial region of an object-side surface of the second lens 720 may have a convex shape, and a paraxial region of an image-side surface of the second lens 720 may have a concave shape.

The third lens 730 may have a negative refractive power, and respective paraxial regions of an object-side surface and an image-side surface of the third lens 730 may each have a concave shape.

The fourth lens 740 may have a positive refractive power, and respective paraxial regions of an object-side surface and an image-side surface of the fourth lens 740 may each have a convex shape.

The fifth lens 750 may have a positive refractive power, and respective paraxial regions of an object-side surface and an image-side surface of the fifth lens 750 may each have a convex shape.

Both surfaces of the front lens FL and both surfaces of each of the first lens 710 through the fifth lens 750 may have aspherical surface coefficients as listed in Table 12 below. For example, both the object-side surface and the image-side surface of the front lens FL may be aspherical surfaces, and both the object-side surface and the image-side surface of each of the first lens 710 through the fifth lens 750 may be aspherical surfaces.

TABLE 14

| | S1 | S2 | S6 | S7 | S8 | S9 |
|---|---|---|---|---|---|---|
| K | −5.19E−02 | 1.12E+00 | 1.22E−01 | 4.07E+01 | 6.78E+00 | 1.51E+00 |
| A | 1.18E−01 | 8.82E−04 | −1.05E+00 | 5.69E−02 | 1.02E+00 | 1.44E−01 |
| B | 5.56E−03 | −2.31E−03 | −4.89E−01 | −2.88E−01 | 7.59E−02 | 3.03E−02 |
| C | −2.84E−04 | −6.11E−04 | −4.17E−02 | 3.79E−02 | 2.43E−03 | −1.06E−03 |
| D | −1.00E−06 | 4.90E−05 | −4.21E−02 | −3.27E−02 | −1.11E−02 | −6.50E−03 |
| E | 7.60E−05 | 1.60E−05 | −1.64E−02 | −1.14E−02 | 1.03E−02 | −8.06E−04 |
| F | −1.00E−05 | 0.00E+00 | 9.94E−03 | 5.73E−04 | −3.77E−03 | 1.28E−03 |
| G | 0.00E+00 | 0.00E+00 | 6.75E−03 | −1.31E−03 | −2.16E−03 | −7.00E−06 |
| H | 0.00E+00 | 0.00E+00 | 1.54E−03 | 6.36E−04 | 2.89E−03 | 4.30E−05 |
| | S10 | S11 | S12 | S13 | S14 | S15 |
| K | −1.16E+00 | −1.66E+00 | 4.09E+01 | −1.36E+01 | −3.16E+00 | −7.998E+00 |
| A | −1.77E−02 | −1.84E−01 | 1.27E−01 | 1.07E−01 | −3.55E−02 | −1.261E−03 |
| B | −1.07E−03 | −7.70E−04 | −7.95E−03 | 7.25E−03 | −1.22E−02 | −1.254E−02 |
| C | 9.50E−04 | 1.62E−03 | −1.31E−03 | −1.92E−03 | −3.83E−03 | −3.019E−03 |
| D | −2.10E−05 | 3.89E−04 | 1.45E−04 | −1.38E−04 | −6.15E−04 | −8.158E−04 |
| E | −1.60E−05 | 6.30E−05 | 3.80E−05 | 4.40E−05 | −5.80E−05 | −8.900E−05 |
| F | 0.00E+00 | 0.00E+00 | 0.00E+00 | 0.00E+00 | 0.00E+00 | 0.000E+00 |
| G | 0.00E+00 | 0.00E+00 | 0.00E+00 | 0.00E+00 | 0.00E+00 | 0.000E+00 |
| H | 0.00E+00 | 0.00E+00 | 0.00E+00 | 0.00E+00 | 0.00E+00 | 0.000E+00 |

In addition, the optical imaging system 700 configured as described above may have the aberration characteristics illustrated in FIG. 18.

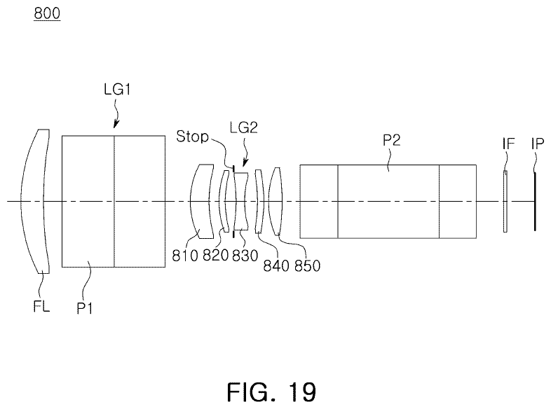

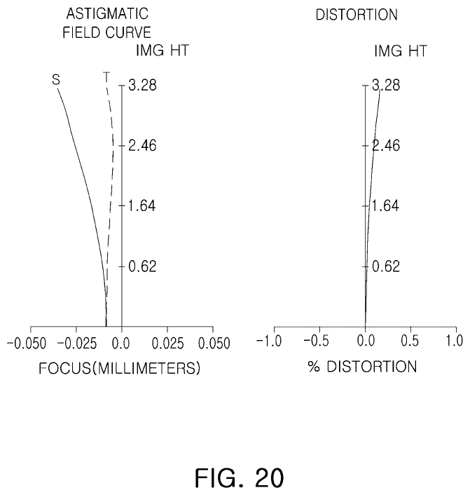

FIG. 19 is a configuration diagram of an optical imaging system according to an eighth embodiment of the present disclosure, and FIG. 20 is graphs illustrating aberration characteristics of the optical imaging system illustrated in FIG. 19.

An optical imaging system 800 according to an eighth embodiment of the present disclosure will be described with reference to FIGS. 19 and 20. FIG. 19 schematically illustrates an optical path of the optical imaging system 800 according to the eighth embodiment of the present disclosure in an unfolded state.

Referring to FIG. 19, the optical imaging system 800 according to an eighth embodiment of the present disclosure may include a first lens group LG1 and a second lens group LG2.

The first lens group LG1 may include a front lens FL and a first reflective member P1, and the second lens group LG2 may include a first lens 810, a second lens 820, a third lens 830, a fourth lens 840, and a fifth lens 850 sequentially disposed in ascending numerical order along an optical axis of the second lens group LG2 from an object side of the second lens group LG2 toward an image side of the second lens group LG2.

The front lens FL may be disposed in front of the first reflective member P1.

The first reflective member P1 may include an incident surface PS1, a first reflective surface R1, and an exit surface PS2 as shown in FIG. 3.

The optical imaging system 800 may further include a second reflective member P2 disposed behind the second lens group LG2. The second reflective member P2 may include a second reflective surface R2 and a third reflective surface R3 as shown in FIG. 4.

In addition, the optical imaging system 800 may further include a filter IF and an imaging plane IP disposed after the second reflective member P2.

The imaging plane IP may refer to a surface on which a focal point is formed by the optical imaging system 800. For example, the imaging plane IP may refer to one surface of an image sensor IS on which light is received as shown in FIGS. 3 and 4.

A stop may be disposed between the second lens 820 and the third lens 830. For example, the stop may be disposed at an edge of an object-side surface of the third lens 830.

Characteristics of each element (a radius of curvature, a thickness of an element or a distance between elements, a refractive index, an Abbe number, and an effective radius) are listed in Table 15 below.

TABLE 15

| | Surface | Radius of | Thickness | Refractive | Abbe | Effective |
|---|---|---|---|---|---|---|
| Element | No. | Curvature | or Distance | Index | Number | Radius |
| Front | S1 | 17.859 | 2.500 | 1.546 | 56.0 | 7.811 |
| Lens | S2 | 50.669 | 2.000 | | | 7.514 |
| First | S3 | Infinity | 5.550 | 1.518 | 64.1 | 7.113 |
| Reflective | S4 | Infinity | 5.550 | 1.518 | 64.1 | 6.083 |
| Member | S5 | Infinity | 2.716 | | | 5.053 |
| First | S6 | 9.930 | 2.000 | 1.546 | 56.0 | 4.000 |
| Lens | S7 | 30.291 | 1.140 | | | 3.632 |
| Second | S8 | 15.429 | 0.500 | 1.569 | 40.4 | 3.359 |
| Lens | S9 | 11.453 | 1.385 | | | 3.209 |
| Third | S10 (Stop) | −13.707 | 0.767 | 1.725 | 29.4 | 3.085 |
| Lens | S11 | 7.862 | 1.472 | | | 3.135 |
| Fourth | S12 | −23.392 | 0.693 | 1.678 | 19.2 | 3.340 |
| Lens | S13 | −16.455 | 0.499 | | | 3.433 |
| Fifth | S14 | 8.898 | 1.436 | 1.550 | 52.3 | 3.699 |
| Lens | S15 | −18.526 | 2.000 | | | 3.700 |
| Second | S16 | Infinity | 4.000 | 1.722 | 29.5 | 3.650 |
| Reflective | S17 | Infinity | 11.000 | 1.722 | 29.5 | 3.599 |
| Member | S18 | Infinity | 4.000 | 1.722 | 29.5 | 3.460 |
| | S19 | Infinity | 3.000 | | | 3.409 |
| Filter | S20 | Infinity | 0.210 | 1.519 | 64.2 | 3.344 |
| | S21 | Infinity | 3.076 | | | 3.341 |
| Imaging | S22 | Infinity | | | | 3.277 |
| Plane | | | | | | |

For reference, “Distance” in Table 15 may be based on a position of the second reflective member P2 when an object distance is infinity.

In the eighth embodiment of the present disclosure, the front lens FL may have a positive refractive power, a paraxial region of an object-side surface of the front lens FL may have a convex shape, and a paraxial region of an image-side surface of the front lens FL may have a concave shape.

The first lens 810 may have a positive refractive power, a paraxial region of an object-side surface of the first lens 810 may have a convex shape, and a paraxial region of an image-side surface of the first lens 810 may have a concave shape.

The second lens 820 may have a negative refractive power, a paraxial region of an object-side surface of the second lens 820 may have a convex shape, and a paraxial region of an image-side surface of the second lens 820 may have a concave shape.

The third lens 830 may have a negative refractive power, and respective paraxial regions of an object-side surface and an image-side surface of the third lens 830 may each have a concave shape.

The fourth lens 840 may have a positive refractive power, a paraxial region of an object-side surface of the fourth lens 840 may have a concave shape, and a paraxial region of an image-side surface of the fourth lens 840 may have a convex shape.

The fifth lens 850 may have a positive refractive power, and respective paraxial regions of an object-side surface and an image-side surface of the fifth lens 850 may have a convex shape.

Both surfaces of the front lens FL and both surfaces of each of each of the first lens 810 through the fifth lens 850 may have an aspherical surface coefficients as listed in Table 16 below. For example, both the object-side surface and the image-side surface of the front lens FL may be aspherical surfaces, and both the object-side surface and the image-side surface of each of the first lens 810 through the fifth lens 850 may be aspherical surfaces.

TABLE 16

| | S1 | S2 | S6 | S7 | S8 | S9 |
|---|---|---|---|---|---|---|
| K | −4.92E−02 | 1.46E+01 | 4.03E−01 | 3.73E+01 | 6.49E+00 | −5.49E−01 |
| A | 1.06E−01 | −2.66E−03 | −1.04E+00 | 6.70E−02 | 1.09E+00 | 1.26E−01 |
| B | 6.19E−03 | −2.39E−03 | −5.68E−01 | −3.86E−01 | 8.62E−02 | 3.49E−02 |
| C | −4.00E−06 | −3.93E−04 | −3.18E−02 | 3.59E−02 | −4.24E−02 | −1.27E−02 |
| D | −5.00E−05 | −2.50E−05 | −5.06E−02 | −2.12E−02 | 1.77E−02 | −5.25E−03 |
| E | 4.00E−06 | −4.40E−07 | −2.35E−02 | −6.16E−03 | 2.45E−02 | 8.92E−04 |
| F | 0.00E+00 | 0.00E+00 | 1.38E−02 | 4.96E−03 | −3.35E−04 | 1.38E−03 |
| G | 0.00E+00 | 0.00E+00 | 1.26E−02 | 3.05E−03 | 7.13E−04 | 1.64E−04 |
| H | 0.00E+00 | 0.00E+00 | 2.81E−03 | 6.06E−04 | 2.31E−03 | 7.10E−05 |
| | S10 | S11 | S12 | S13 | S14 | S15 |
| K | 1.34E+00 | −2.28E+00 | 2.53E+01 | −8.62E+00 | −3.84E+00 | −3.606E+00 |
| A | −2.65E−02 | −1.30E−01 | 1.33E−01 | 4.45E−02 | 8.59E−03 | 4.638E−02 |
| B | −3.14E−03 | 3.53E−03 | −8.36E−04 | −1.56E−03 | −1.50E−04 | −1.776E−04 |
| C | 6.46E−04 | 2.00E−03 | −6.56E−04 | −2.57E−03 | −2.72E−03 | −1.838E−03 |
| D | 2.11E−04 | 3.44E−04 | 4.30E−05 | −2.30E−04 | −6.09E−04 | −7.800E−04 |
| E | 2.00E−05 | 3.90E−05 | 1.30E−05 | 1.60E−05 | −7.00E−05 | −9.300E−05 |
| F | 0.00E+00 | 0.00E+00 | 0.00E+00 | 0.00E+00 | 0.00E+00 | 0.000E+00 |
| G | 0.00E+00 | 0.00E+00 | 0.00E+00 | 0.00E+00 | 0.00E+00 | 0.000E+00 |
| H | 0.00E+00 | 0.00E+00 | 0.00E+00 | 0.00E+00 | 0.00E+00 | 0.000E+00 |

In addition, the optical imaging system 800 configured as described above may have the aberration characteristics illustrated in FIG. 20.

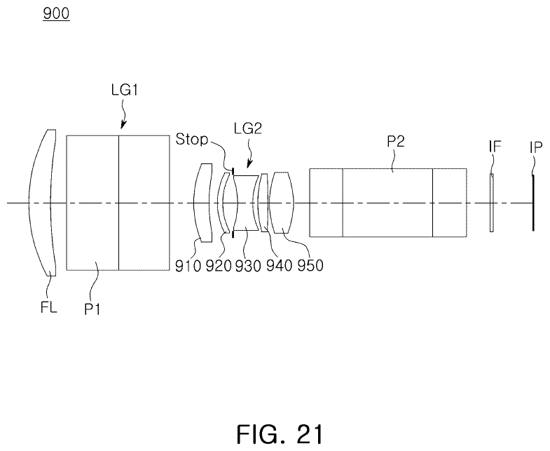

FIG. 21 is a configuration diagram of an optical imaging system according to a ninth embodiment of the present disclosure, and FIG. 22 is graphs illustrating aberration characteristics of the optical imaging system illustrated in FIG. 21.

An optical imaging system 900 according to a ninth embodiment of the present disclosure will be described with reference to FIGS. 21 and 22. FIG. 21 schematically illustrates an optical path of the optical imaging system 900 according to the ninth embodiment of the present disclosure in an unfolded state.

Referring to FIG. 21, the optical imaging system 900 according to the ninth embodiment of the present disclosure may include a first lens group LG1 and a second lens group LG2.

The first lens group LG1 may include a front lens FL and a first reflective member P1, and the second lens group LG2 may include a first lens 910, a second lens 920, a third lens 930, a fourth lens 940, and a fifth lens 950 sequentially disposed in ascending numerical order along an optical axis of the second lens group LG2 from an object side of the second lens group LG2 toward an image side of the second lens group LG2.

The front lens FL may be disposed in front of the first reflective member P1.

The first reflective member P1 may include an incident surface PS1, a first reflective surface R1, and an exit surface PS2 as shown in FIG. 3.

The optical imaging system 900 may further include a second reflective member P2 disposed behind the second lens group LG2. The second reflective member P2 may include a second reflective surface R2 and a third reflective surface R3 as shown in FIG. 4.

In addition, the optical imaging system 900 may further include a filter IF and an imaging plane IP disposed after the second reflective member P2.

The imaging plane IP may refer to a surface on which a focal point is formed by the optical imaging system 900. For example, the imaging plane IP may refer to one surface of an image sensor IS on which light is received as shown in FIGS. 3 and 4.

A stop may be disposed between the second lens 920 and the third lens 930. For example, the stop may be disposed at an edge of an object-side surface of the third lens 930.

Characteristics of each element (a radius of curvature, a thickness of an element or a distance between elements, a refractive index, an Abbe number, and an effective radius) are listed in Table 17 below.

TABLE 17

| | Surface | Radius of | Thickness | Refractive | Abbe | Effective |
|---|---|---|---|---|---|---|
| Element | No. | Curvature | or Distance | Index | Number | Radius |
| Front | S1 | 20.351 | 2.500 | 1.548 | 53.9 | 8.787 |
| Lens | S2 | 56.373 | 2.000 | | | 8.543 |
| First | S3 | Infinity | 6.300 | 1.518 | 64.1 | 8.158 |
| Reflective | S4 | Infinity | 6.300 | 1.518 | 64.1 | 6.983 |
| Member | S5 | Infinity | 2.766 | | | 5.808 |
| First | S6 | 10.372 | 2.000 | 1.546 | 56.0 | 4.700 |
| Lens | S7 | 41.096 | 1.111 | | | 4.326 |
| Second | S8 | 12.590 | 0.500 | 1.576 | 35.4 | 3.641 |
| Lens | S9 | 8.829 | 1.870 | | | 3.362 |
| Third | S10 (Stop) | −8.394 | 1.847 | 1.754 | 27.9 | 3.164 |
| Lens | S11 | 6.425 | 0.538 | | | 3.348 |
| Fourth | S12 | 21.920 | 1.295 | 1.678 | 19.2 | 3.437 |
| Lens | S13 | −29.682 | 0.100 | | | 3.505 |
| Fifth | S14 | 9.096 | 2.973 | 1.546 | 56.0 | 3.684 |
| Lens | S15 | −10.538 | 2.000 | | | 3.750 |
| Second | S16 | Infinity | 4.000 | 1.722 | 29.5 | 3.691 |
| Reflective | S17 | Infinity | 11.000 | 1.722 | 29.5 | 3.640 |
| Member | S18 | Infinity | 4.000 | 1.722 | 29.5 | 3.500 |
| | S19 | Infinity | 3.000 | | | 3.449 |
| Filter | S20 | Infinity | 0.210 | 1.519 | 64.2 | 3.383 |
| | S21 | Infinity | 4.929 | | | 3.380 |
| Imaging | S22 | Infinity | | | | 3.277 |
| Plane | | | | | | |

For reference, “Distance” in Table 17 may be based on a position of the second reflective member P2 when an object distance is infinity.

In the ninth embodiment of the present disclosure, the front lens FL may a have positive refractive power, a paraxial region of an object-side surface of the front lens FL may have a convex shape, and a paraxial region of an image-side surface of the front lens FL may have a concave shape.

The first lens 910 may have a positive refractive power, a paraxial region of an object-side surface of the first lens 910 may have a convex shape, and a paraxial region of an image-side surface of the first lens 910 may have a concave shape.

The second lens 920 may have a negative refractive power, a paraxial region of an object-side surface of the second lens 920 may have a convex shape, and a paraxial region of an image-side surface of the second lens 920 may have a concave shape.

The third lens 930 may have a negative refractive power, and respective paraxial regions of an object-side surface and an image-side surface of the third lens 930 may each have a concave shape.

The fourth lens 940 may have a positive refractive power, and respective paraxial regions of an object-side surface and an image-side surface of the fourth lens 940 may each have a convex shape.

The fifth lens 950 may have a positive refractive power, and respective paraxial regions of an object-side surface and an image-side surface of the fifth lens 950 may each have a convex shape.

Both surfaces of the front lens FL and a surface of each of the first lens 910 through the fifth lens 950 may have aspherical surface coefficients as listed in Table 18 below. For example, both the object-side surface and the image-side surface of the front lens FL may be aspherical surfaces, and both the object-side surface and the image-side surface of each of the first lens 910 through the fifth lens 950 may be aspherical surfaces.

TABLE 18

| | S1 | S2 | S6 | S7 | S8 | S9 |
|---|---|---|---|---|---|---|
| K | 1.03E−01 | 2.42E+01 | 1.27E−01 | 2.71E+01 | 6.30E+00 | 6.57E−01 |
| A | 1.10E−01 | −7.82E−02 | −1.14E+00 | −1.53E−01 | 9.21E−01 | 1.65E−01 |
| B | −1.10E−02 | −2.69E−02 | −4.78E−01 | −1.44E−01 | 2.03E−01 | 3.29E−02 |
| C | −5.52E−03 | −6.25E−03 | −1.11E−01 | −3.39E−03 | 9.01E−03 | 3.38E−04 |
| D | −1.30E−03 | −8.57E−04 | −2.50E−02 | −2.23E−03 | −6.83E−03 | 5.04E−04 |
| E | −2.17E−04 | −7.70E−05 | −9.43E−03 | −2.08E−04 | −8.02E−04 | −1.52E−04 |
| F | −2.70E−05 | −3.00E−06 | −3.16E−03 | −2.09E−03 | 1.19E−03 | −8.70E−05 |
| G | 0.00E+00 | 0.00E+00 | 1.23E−03 | 7.77E−04 | 1.83E−03 | −6.10E−05 |
| H | 0.00E+00 | 0.00E+00 | 3.03E−04 | −1.82E−04 | −1.62E−04 | −1.10E−05 |
| | S10 | S11 | S12 | S13 | S14 | S15 |
| K | −6.34E−01 | −8.31E−01 | 2.25E+01 | −4.32E+01 | −3.47E+00 | −2.687E−02 |
| A | 2.90E−03 | −1.17E−01 | 9.67E−02 | 8.91E−02 | −4.49E−02 | −5.344E−03 |
| B | −5.52E−03 | −6.16E−03 | −6.79E−04 | 1.60E−02 | −3.57E−03 | −4.846E−03 |
| C | 1.90E−05 | −2.08E−04 | −8.73E−04 | 1.94E−03 | −7.67E−04 | −8.760E−04 |
| D | 1.74E−04 | 1.08E−04 | 1.82E−04 | 2.86E−04 | −1.22E−04 | −1.384E−04 |
| E | 2.40E−05 | 2.90E−05 | 4.80E−05 | 4.40E−05 | −1.80E−05 | −3.100E−05 |
| F | 0.00E+00 | 0.00E+00 | 0.00E+00 | 0.00E+00 | 0.00E+00 | 0.000E+00 |
| G | 0.00E+00 | 0.00E+00 | 0.00E+00 | 0.00E+00 | 0.00E+00 | 0.000E+00 |
| H | 0.00E+00 | 0.00E+00 | 0.00E+00 | 0.00E+00 | 0.00E+00 | 0.000E+00 |

In addition, the optical imaging system configured 900 as described above may have the aberration characteristics illustrated in FIG. 22.

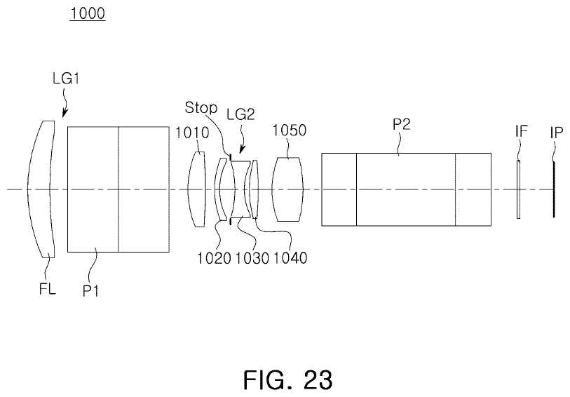

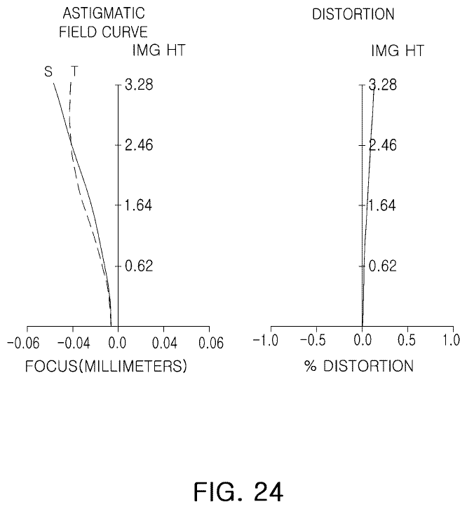

FIG. 23 is a configuration diagram of an optical imaging system according to a tenth embodiment of the present disclosure, and FIG. 24 is graphs illustrating aberration characteristics of the optical imaging system illustrated in FIG. 23.

An optical imaging system 1000 according to a tenth embodiment of the present disclosure will be described with reference to FIGS. 23 and 24. FIG. 23 schematically illustrates an optical path of the optical imaging system 1000 according to the tenth embodiment of the present disclosure in an unfolded state.

The optical imaging system 1000 according to the tenth embodiment of the present disclosure may include a first lens group LG1 and a second lens group LG2.

The first lens group LG1 may include a front lens FL and a first reflective member P1, and the second lens group LG2 may include a first lens 1010, a second lens 1020, a third lens 1030, a fourth lens 1040, and a fifth lens 1050 sequentially disposed in ascending numerical order along an optical axis of the second lens group LG2 from an object side of the second lens group LG2 toward an image side of the second lens group LG2.

The front lens FL may be disposed in front of the first reflective member P1.

The first reflective member P1 may include an incident surface PS1, a first reflective surface R1, and an exit surface PS2 as shown in FIG. 3.

The optical imaging system 1000 may further include a second reflective member P2 disposed behind the second lens group LG2. The second reflective member P2 may include a second reflective surface R2 and a third reflective surface R3 as shown in FIG. 4.

In addition, the optical imaging system 1000 may further include a filter IF and an imaging plane IP disposed after the second reflective member P2.

An imaging plane IP may refer to a surface on which a focal point is formed by the optical imaging system 1000. For example, the imaging plane IP may refer to one surface of an image sensor IS on which light is received as shown in FIGS. 3 and 4.

A stop may be disposed between the second lens 1020 and the third lens 1030. For example, the stop may be disposed at an edge of an object-side surface of the third lens 1030.

Characteristics of each element (a radius of curvature, a thickness of an element or a distance between elements, a refractive index, an Abbe number, and an effective radius) are listed in Table 19 below.

TABLE 19

| | Surface | Radius of | Thickness | Refractive | Abbe | Effective |
|---|---|---|---|---|---|---|
| Element | No. | Curvature | or Distance | Index | Number | Radius |
| Front | S1 | 20.082 | 2.500 | 1.554 | 47.6 | 7.727 |
| Lens | S2 | 52.575 | 2.000 | | | 7.427 |
| First | S3 | Infinity | 5.700 | 1.518 | 64.1 | 7.052 |
| Reflective | S4 | Infinity | 5.700 | 1.518 | 64.1 | 6.098 |
| Member | S5 | Infinity | 2.000 | | | 5.143 |
| First | S6 | 10.667 | 2.000 | 1.546 | 56.0 | 4.400 |
| Lens | S7 | −75.848 | 1.000 | | | 4.202 |
| Second | S8 | 12.506 | 0.500 | 1.602 | 29.7 | 3.629 |
| Lens | S9 | 8.077 | 1.891 | | | 3.358 |
| Third | S10 (Stop) | −9.490 | 1.050 | 1.761 | 27.6 | 3.224 |
| Lens | S11 | 6.397 | 0.534 | | | 3.270 |
| Fourth | S12 | 21.559 | 0.973 | 1.678 | 19.2 | 3.347 |
| Lens | S13 | −29.368 | 1.484 | | | 3.373 |
| Fifth | S14 | 10.807 | 3.568 | 1.546 | 56.0 | 3.749 |
| Lens | S15 | −13.634 | 2.000 | | | 3.750 |
| Second | S16 | Infinity | 4.000 | 1.722 | 29.5 | 3.691 |
| Reflective | S17 | Infinity | 11.000 | 1.722 | 29.5 | 3.637 |
| Member | S18 | Infinity | 4.000 | 1.722 | 29.5 | 3.488 |
| | S19 | Infinity | 3.000 | | | 3.434 |
| Filter | S20 | Infinity | 0.210 | 1.519 | 64.2 | 3.364 |
| | S21 | Infinity | 3.772 | | | 3.361 |
| Imaging | S22 | Infinity | | | | 3.278 |
| Plane | | | | | | |

For reference, “Distance” in Table 19 may be based on a position of the second reflective member P2 when an object distance is infinity.

In the tenth embodiment of the present disclosure, the front lens FL may have a positive refractive power, a paraxial region of an object-side surface of the front lens FL may have a convex shape, and a paraxial region of an image-side surface of the front lens FL may have a concave shape.

The first lens 1010 may have a positive refractive power, and respective paraxial regions of an object-side surface and an image-side surface of the first lens 1010 may each have a convex shape.

The second lens 1020 may have a negative refractive power, a paraxial region of an object-side surface of the second lens 1020 may have a convex shape, and a paraxial region of an image-side surface of the second lens 1020 may have a concave shape.

The third lens 1030 may have a negative refractive power, and respective paraxial regions of an object-side surface and an image-side surface of the third lens 1030 may each have a concave shape.

The fourth lens 1040 may have a positive refractive power, and respective paraxial regions of an object-side surface and an image-side surface of the fourth lens 1040 may each have a convex shape.

The fifth lens 1050 may have a positive refractive power, and respective paraxial regions of an object-side surface and an image-side surface of the fifth lens 1050 may each have a convex shape.

Both surfaces of the front lens FL and both surfaces of each of the first lens 1010 through the fifth lens 1050 may have an aspherical surface coefficients as listed in Table 20 below. For example, both the object-side surface and the image-side surface of the front lens FL may be aspherical surfaces, and both the object-side surface and the image-side surface of each of the first lens 1010 through the fifth lens 1050 may be aspherical surfaces.

TABLE 20

| | S1 | S2 | S6 | S7 | S8 | S9 |
|---|---|---|---|---|---|---|
| K | 2.12E−01 | 2.59E+01 | −1.02E−01 | −4.84E+01 | 6.25E+00 | 6.38E−01 |
| A | 7.04E−02 | −5.10E−02 | −1.20E+00 | −1.17E−01 | 8.56E−01 | 1.64E−01 |
| B | −7.33E−03 | −1.79E−02 | −4.62E−01 | −1.46E−01 | 2.30E−01 | 3.35E−02 |
| C | −3.19E−03 | −3.79E−03 | −1.12E−01 | −5.11E−03 | −4.69E−03 | 1.81E−03 |
| D | −6.70E−04 | −4.34E−04 | −2.89E−02 | −5.82E−03 | −6.35E−03 | 2.59E−03 |
| E | −7.40E−05 | −3.40E−05 | −6.66E−03 | 1.84E−03 | 1.77E−03 | 1.86E−03 |
| F | −6.00E−06 | −1.00E−06 | −1.55E−03 | −3.47E−03 | −1.14E−04 | 4.98E−04 |
| G | 0.00E+00 | 0.00E+00 | −1.51E−03 | −2.72E−03 | 1.70E−03 | 1.36E−04 |
| H | 0.00E+00 | 0.00E+00 | −6.78E−04 | −7.21E−04 | 1.64E−04 | 1.20E−05 |

| | S10 | S11 | S12 | S13 | S14 | S15 |
|---|---|---|---|---|---|---|
| K | −1.11E+00 | −8.64E−01 | 2.21E+01 | −4.33E+01 | −2.88E+00 | −7.979E−02 |
| A | 2.19E−02 | −1.00E−01 | 9.22E−02 | 8.46E−02 | −2.24E−02 | 1.403E−02 |
| B | −3.50E−03 | −2.27E−03 | 2.82E−03 | 1.70E−02 | 3.36E−03 | 2.713E−04 |
| C | 2.90E−04 | 4.81E−04 | 3.13E−04 | 2.66E−03 | 7.47E−04 | 2.768E−04 |
| D | 2.10E−04 | 1.42E−04 | 3.42E−04 | 3.99E−04 | 4.90E−05 | 7.900E−05 |
| E | 2.80E−05 | 2.30E−05 | 5.50E−05 | 4.40E−05 | −1.20E−05 | −1.000E−05 |
| F | 0.00E+00 | 0.00E+00 | 0.00E+00 | 0.00E+00 | 0.00E+00 | 0.000E+00 |
| G | 0.00E+00 | 0.00E+00 | 0.00E+00 | 0.00E+00 | 0.00E+00 | 0.000E+00 |
| H | 0.00E+00 | 0.00E+00 | 0.00E+00 | 0.00E+00 | 0.00E+00 | 0.000E+00 |

In addition, the optical imaging system configured 1000 as described above may have the aberration characteristics illustrated in FIG. 24.

Table 21 below lists values of properties of the optical imaging systems 100 to 1000 according to the first embodiment to the tenth embodiment.

TABLE 21

| Value | Emb. 1 | Emb. 2 | Emb. 3 | Emb. 4 | Emb. 5 |
|---|---|---|---|---|---|
| R1 | 23.960 | 22.674 | 25.176 | 22.994 | 23.455 |
| R2 | 47.185 | 41.111 | 60.000 | 60.000 | 60.000 |
| f | 34.915 | 34.915 | 34.915 | 34.915 | 34.913 |
| f1 | 23.474 | 24.576 | 20.271 | 21.599 | 17.940 |
| f2 | −122.893 | −39.543 | −32.358 | −36.412 | −40.187 |
| f3 | −5.210 | −6.421 | −5.257 | −5.760 | −5.547 |
| f4 | 40.942 | 22.714 | 24.889 | 18.268 | 22.926 |
| f5 | 8.859 | 10.683 | 9.673 | 12.707 | 11.762 |
| d1 | 8.683 | 7.759 | 7.280 | 8.128 | 8.568 |
| h1 | 7.660 | 7.525 | 7.109 | 7.609 | 7.666 |
| h2 | 4.650 | 4.650 | 4.700 | 4.700 | 4.700 |
| a | 26.281 | 26.279 | 26.279 | 26.280 | 26.278 |
| b | 11.000 | 11.000 | 11.000 | 11.000 | 11.000 |
| Fno | 2.861 | 2.851 | 2.965 | 2.921 | 2.889 |
| fG1 | 80.000 | 80.000 | 75.000 | 64.859 | 66.912 |
| fG2 | 41.085 | 40.889 | 40.922 | 44.967 | 46.129 |
| Him | 2.622 | 2.622 | 2.622 | 2.622 | 2.622 |
| AFd | 1.709 | 1.712 | 1.690 | 1.707 | 1.720 |
| TTL | 55.437 | 54.478 | 56.293 | 56.387 | 55.959 |
| BFL | 28.556 | 27.599 | 29.414 | 29.507 | 29.081 |
| IMG HT | 3.277 | 3.277 | 3.277 | 3.277 | 3.277 |
| fi_300 | 31.275 | 31.275 | 31.275 | 31.275 | 31.273 |
| Value | Emb. 6 | Emb. 7 | Emb. 8 | Emb. 9 | Emb. 10 |
| R1 | 20.879 | 17.358 | 17.859 | 20.351 | 20.082 |
| R2 | 47.642 | 27.260 | 50.669 | 56.374 | 52.575 |
| f | 34.915 | 34.915 | 34.915 | 34.915 | 34.915 |
| f1 | 23.149 | 24.039 | 26.145 | 24.835 | 17.265 |
| f2 | −110.727 | −40.163 | −81.794 | −53.939 | −39.539 |
| f3 | −5.200 | −6.320 | −6.786 | −4.582 | −4.882 |
| f4 | 41.975 | 23.672 | 78.664 | 18.787 | 18.479 |
| f5 | 9.096 | 10.924 | 11.131 | 9.445 | 11.640 |
| d1 | 10.372 | 9.254 | 8.266 | 9.066 | 7.700 |
| h1 | 8.292 | 8.167 | 7.811 | 8.787 | 7.727 |
| h2 | 4.350 | 4.650 | 4.000 | 4.700 | 4.400 |
| a | 27.200 | 27.173 | 24.158 | 27.300 | 26.700 |
| b | 11.000 | 11.000 | 11.000 | 11.000 | 11.000 |
| Fno | 2.952 | 2.899 | 2.957 | 2.935 | 2.898 |
| fG1 | 65.888 | 80.000 | 49.180 | 56.683 | 57.036 |
| fG2 | 42.201 | 40.587 | 53.814 | 42.175 | 44.716 |
| Him | 2.622 | 2.622 | 2.622 | 2.622 | 2.622 |
| AFd | 1.671 | 1.678 | 1.703 | 1.659 | 1.675 |
| TTL | 61.099 | 60.874 | 55.494 | 61.239 | 58.882 |
| BFL | 29.199 | 29.001 | 27.286 | 29.139 | 27.982 |
| IMG HT | 3.277 | 3.277 | 3.277 | 3.277 | 3.277 |
| fi_300 | 31.275 | 31.275 | 31.275 | 31.275 | 31.275 |

In Table 21, R1 may be a radius of curvature of the incident surface PS1 of the first reflective member P1, and R2 may be a radius of curvature of the exit surface PS2 of the first reflective member P1 (in Embodiments 1 through 5).

Alternatively, R1 may be a radius of curvature of the object-side surface of the front lens FL, and R2 may be a radius of curvature of the image-side surface of the front lens FL (in Embodiments 6 through 10).

f may be an overall focal length of an optical imaging system, f1 may be a focal length of a first lens, f2 may be a focal length of a second lens, f3 may be a focal length of a third lens, f4 may be a focal length of a fourth lens, and f5 may be a focal length of a fifth lens.

d1 may be a distance between the first reflective surface of the first reflective member P1 and an object-side surface of a first lens of a second lens group LG2.

h1 may be an effective radius of a first surface of the first lens group LG1 (the incident surface PS1 of the first reflective member P1 in Embodiments 1 through 5, and the object-side surface of the front lens FL in Embodiments 6 through 10).

h2 may be an effective radius of the object-side surface of the first lens of the second lens group LG2.

a may be a distance between a center of the first reflective surface R1 of the first reflective member P′ and a center of the second reflective surface R2 of the second reflective member P2 when an object distance is infinity, and b may be a distance between a center of the second reflective surface R2 and a center of the third reflective surface of the second reflective member P2.

Fno may be an F-number of the optical imaging system, fG1 may be a focal length of the first lens group, and fG2 may be a focal length of the second lens group.

Him may be one half of a length of the imaging plane IP in a horizontal direction. The horizontal direction may refer to a direction from the second reflective surface R2 toward the third reflective surface R3 (or an opposite direction thereof).

AFd may be an amount of movement of the second reflective member between a closest position to the second lens group (when the object distance is infinity) and a farthest position from the second lens group (when the object distance is a minimum (for example, 300 mm)).

TTL may be a sum of a distance along the optical axis from the first surface of the first lens group LG1 to the first reflective surface R1 of the first reflective member P1, a distance along the optical axis from the first reflective surface R1 of the first reflective member P1 to the second reflective surface R2 of the second reflective member P2, a distance along the optical axis from the second reflective surface R2 of the second reflective member P2 to the third reflective surface R3 of the second reflective member P2, and a distance along the optical axis from the third reflective surface R3 of the second reflective member P2 to the imaging plane IP.

BFL may be a sum of a distance along the optical axis from a last surface of the second lens group LG2 to the second reflective surface R2 of the second reflective member P1, a distance along the optical axis from the second reflective surface R2 of the second reflective member P2 to the third reflective surface R3 of the second reflective member P2, and a distance along the optical axis from the third reflective surface R3 of the second reflective member P2 to the imaging plane IP.

IMG HT may be one half of a diagonal length of the imaging plane.

fi_300 may be a value of fi when the object distance is 300 mm, where fi=(object distance×f)/(object distance+f).

Table 22 below lists values of Conditional Expressions 1 to 46 of the optical imaging systems 100 to 1000 according to the first embodiment to the tenth embodiment.

TABLE 22

| Conditional Expression | Emb. 1 | Emb. 2 | Emb. 3 | Emb. 4 | Emb. 5 |
|---|---|---|---|---|---|
| fG1/fG2 | 1.947 | 1.957 | 1.833 | 1.442 | 1.451 |
| h2 + Him | 7.272 | 7.272 | 7.322 | 7.322 | 7.322 |
| a/f | 0.753 | 0.753 | 0.753 | 0.753 | 0.753 |
| AFd/(f-fi) | 0.470 | 0.470 | 0.464 | 0.469 | 0.473 |
| (h2 + Him)/b | 0.661 | 0.661 | 0.666 | 0.666 | 0.666 |
| f/fG1 | 0.436 | 0.436 | 0.466 | 0.538 | 0.522 |
| f/fG2 | 0.850 | 0.854 | 0.853 | 0.776 | 0.757 |
| RG1_S1/fG1 | 0.300 | 0.283 | 0.336 | 0.355 | 0.351 |
| fG1/TTL | 1.443 | 1.468 | 1.332 | 1.150 | 1.196 |
| f/h1 | 4.558 | 4.640 | 4.911 | 4.589 | 4.554 |
| a/TTL | 0.474 | 0.482 | 0.467 | 0.466 | 0.470 |
| h2/h1 | 0.607 | 0.618 | 0.661 | 0.618 | 0.613 |
| BFL/TTL | 0.515 | 0.507 | 0.523 | 0.523 | 0.520 |
| \|(RG1_S1 − RG1_S2)/ | 0.326 | 0.289 | 0.409 | 0.446 | 0.438 |
| (RG1_S1 + RG1_S2)\| | | | | | |
| h2/fG1 | 0.058 | 0.058 | 0.063 | 0.072 | 0.070 |
| TTL/(2 × IMG HT | 8.458 | 8.312 | 8.589 | 8.603 | 8.538 |
| Conditional Expression | Emb. 6 | Emb. 7 | Emb. 8 | Emb. 9 | Emb. 10 |
| fG1/fG2 | 1.561 | 1.971 | 0.914 | 1.344 | 1.276 |
| h2 + Him | 6.972 | 7.272 | 6.622 | 7.322 | 7.022 |
| a/f | 0.779 | 0.778 | 0.692 | 0.782 | 0.765 |
| AFd/(f-fi) | 0.459 | 0.461 | 0.468 | 0.456 | 0.460 |
| (h2 + Him)/b | 0.634 | 0.661 | 0.602 | 0.666 | 0.638 |
| f/fG1 | 0.530 | 0.436 | 0.710 | 0.616 | 0.612 |
| f/fG2 | 0.827 | 0.860 | 0.649 | 0.828 | 0.781 |
| RG1_S1/fG1 | 0.317 | 0.217 | 0.363 | 0.359 | 0.352 |
| fG1/TTL | 1.078 | 1.314 | 0.886 | 0.926 | 0.969 |
| f/h1 | 4.211 | 4.275 | 4.470 | 3.973 | 4.519 |
| a/TTL | 0.445 | 0.446 | 0.435 | 0.446 | 0.453 |
| h2/h1 | 0.525 | 0.569 | 0.512 | 0.535 | 0.569 |
| BFL/TTL | 0.478 | 0.476 | 0.492 | 0.476 | 0.475 |
| \|(RG1_S1 − RG1_S2)/ | 0.391 | 0.222 | 0.479 | 0.470 | 0.447 |
| (RG1_S1 + RG1_S2)\| | | | | | |
| h2/fG1 | 0.066 | 0.058 | 0.081 | 0.083 | 0.077 |
| TTL/(2 × IMG HT | 9.322 | 9.288 | 8.467 | 9.344 | 8.984 |

The values listed in Table 21 and Table 22 may be values obtained by rounding to a third decimal place.

While this disclosure includes specific embodiments, it will be apparent after an understanding of the disclosure of this application that various changes in form and detail may be made in these embodiments without departing from the spirit and scope of claims and their equivalents. Descriptions of features or aspects in each embodiment are to be considered as being applicable to similar features or aspects in other embodiments. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system comprising:
a first lens group having a positive refractive power and a second lens group having a positive refractive power sequentially disposed in ascending numerical order along an optical axis of the optical imaging system from an object side of the optical imaging system toward an imaging plane of the optical imaging system,
wherein the first lens group comprises a first reflective member comprising a first reflective surface,
the second lens group comprises a plurality of lenses,
the optical imaging system further comprises a second reflective member disposed behind the second lens group,
the second reflective member comprises a second reflective surface and a third reflective surface, and
0.50<fG1/fG2<2.50 is satisfied, where fG1 is a focal length of the first lens group, and fG2 is a focal length of the second lens group.

2. The optical imaging system of claim 1, wherein the second reflective surface is disposed behind the second lens group,
the third reflective surface is spaced apart from the second reflective surface in a direction perpendicular to an optical axis of the second lens group, and
the second reflective member is configured to be movable along an optical axis of the second lens group.

3. The optical imaging system of claim 2, wherein 0.50<a/f<1.00 is satisfied, where a is a distance between a center of the first reflective surface and a center of the second reflective surface when the second reflective member is disposed at a closest position to the second lens group, and f is an overall focal length of the optical imaging system.

4. The optical imaging system of claim 2, wherein 0.30<a/TTL<0.60 is satisfied, where a is a distance between a center of the first reflective surface and a center of the second reflective surface when the second reflective member is disposed at a closest position to the second lens group, and TTL is a sum of a distance along the optical axis of the optical imaging system from a first surface of the first lens group to the first reflective surface, a distance along the optical axis of the optical imaging system from the first reflective surface to the second reflective surface, a distance along the optical axis of the optical imaging system from the second reflective surface to the third reflective surface, and a distance along the optical axis of the optical imaging system from the third reflective surface to the imaging plane.

5. The optical imaging system of claim 2, wherein 0.100<AFd/(f−fi)<0.600 is satisfied, where AFd is a distance between a position of the second reflective member disposed at a closest position to the second lens group and a position of the second reflective member disposed at a farthest position from the second lens group, f is an overall focal length of the optical imaging system, and fi is (object distance×f)/(object distance+f).

6. The optical imaging system of claim 1, further comprising an image sensor comprising the imaging plane,
wherein the image sensor is spaced apart from the third reflective surface in a direction parallel to an optical axis of the second lens group,
the second reflective surface and the third reflective surface are spaced apart from each other in a direction perpendicular to the optical axis of the second lens group, and
h2+Him<b is satisfied, where h2 is an effective radius of an object-side surface of a first lens closest to the first lens group among the plurality of lenses of the second lens group, Him is one half of a length of the imaging plane in the direction in which the second reflective surface and the third reflective surface are spaced apart from each other, and b is a distance between a center of the second reflective surface and a center of the third reflective surface.

7. The optical imaging system of claim 1, wherein 0.20<f/fG1<0.90 is satisfied, where f is an overall focal length of the optical imaging system.

8. The optical imaging system of claim 1, wherein 0.40<f/fG2<1.10 is satisfied, where f is an overall focal length of the optical imaging system.

9. The optical imaging system of claim 1, wherein 0.10<RG1_S1/fG1<0.60 is satisfied, where RG1_S1 is a radius of curvature of a first surface of the first lens group.

10. The optical imaging system of claim 1, wherein 0.60<fG1/TTL<1.60 is satisfied, where TTL is a sum of a distance along the optical axis from a first surface of the first lens group to the first reflective surface, a distance along the optical axis from the first reflective surface to the second reflective surface, a distance along the optical axis from the second reflective surface to the third reflective surface, and a distance along the optical axis from the third reflective surface to the imaging plane.

11. The optical imaging system of claim 1, wherein 3.50<f/h1<5.50 is satisfied, where f is an overall focal length of the optical imaging system, and h1 is an effective radius of a first surface of the first lens group.

12. The optical imaging system of claim 1, wherein 0.40<h2/h1<0.80 is satisfied, where h1 is an effective radius of a first surface of the first lens group, and h2 is an effective radius of an object-side surface of a first lens closest to the first lens group among the plurality of lenses of the second lens group.

13. The optical imaging system of claim 1, wherein 0.40<BFL/TTL<0.70 is satisfied, where BFL is a sum of a distance along the optical axis from a last surface of the second lens group to the second reflective surface, a distance along the optical axis from the second reflective surface to the third reflective surface, and a distance along the optical axis from the third reflective surface to the imaging plane, and TTL is a sum of a distance along the optical axis from a first surface of the first lens group to the first reflective surface, a distance along the optical axis from the first reflective surface to the second reflective surface, a distance along the optical axis from the second reflective surface to the third reflective surface, and a distance along the optical axis from the third reflective surface to the imaging plane.

14. The optical imaging system of claim 1, wherein the first reflective member further comprises an incident surface and an exit surface, and
a paraxial region of the incident surface has a convex shape.

15. The optical imaging system of claim 1, wherein the first lens group further comprises a front lens disposed in front of the first reflective member, and
the front lens has a positive refractive power.

16. The optical imaging system of claim 1, wherein the plurality of lenses of the second lens group comprises:
a first lens having a positive refractive power;
a second lens having a refractive power;
a third lens having a negative refractive power;
a fourth lens having a refractive power; and
a fifth lens having a positive refractive power, and
the first lens through the fifth lens are sequentially disposed in ascending numerical order along an optical axis of the second lens group from an object side of the second lens group toward an image side of the second lens group.

17. The optical imaging system of claim 16, wherein the second lens has a negative refractive power, and the fourth lens has a positive refractive power.

18. The optical imaging system of claim 1, further comprising an image sensor comprising the imaging plane,
wherein the image sensor is spaced apart from the third reflective surface in a direction parallel to an optical axis of the second lens group,
the second reflective surface and the third reflective surface are spaced apart from each other in a direction perpendicular to the optical axis of the second lens group, and
0.50< (h2+Him)/b<0.80 is satisfied, where h2 is an effective radius of an object-side surface of a first lens closest to the first lens group among the plurality of lenses of the second lens group, Him is one half of a length of the imaging plane in the direction in which the second reflective surface and the third reflective surface are spaced apart from each other, and b is a distance between a center of the second reflective surface and a center of the third reflective surface.

19. The optical imaging system of claim 1, wherein 0.15<|(RG1_S1−RG1_S2)/(RG1_S1+RG1_S2)|<0.60 is satisfied, where RG1_S1 is a radius of curvature of a first surface of the first lens group, and RG1_S2 is a radius of curvature of a last surface of the first lens group having a curvature.

20. The optical imaging system of claim 1, wherein 0<h2/fG1<0.1 is satisfied, where h2 is an effective radius of an object-side surface of a first lens closest to the first lens group among the plurality of lenses of the second lens group.

21. The optical imaging system of claim 1, wherein 7.0<TTL/(2×IMG HT)<11.0 is satisfied, where TTL is a sum of a distance along the optical axis from a first surface of the first lens group to the first reflective surface, a distance along the optical axis from the first reflective surface to the second reflective surface, a distance along the optical axis from the second reflective surface to the third reflective surface, and a distance along the optical axis from the third reflective surface to the imaging plane, and IMG HT is one half of a diagonal length of the imaging plane.
